(19) United States
(12) Patent Application Publication
(10) Pub. No.: US 2020/0187673 A1
(43) Pub. Date: Jun. 18, 2020

(54) PLAY YARD

(71) Applicant: Henry F. Thorne, Sewickley, PA (US)

(72) Inventor: Henry F. Thorne, Sewickley, PA (US)

(21) Appl. No.: 16/712,085

(22) Filed: Dec. 12, 2019

Related U.S. Application Data
(60) Provisional application No. 62/778,674, filed on Dec. 12, 2018.

(51) Int. Cl. A47D 13/06; F16C 11/10

(52) U.S. Cl. CPC A47D 13/061; F16C 11/10

(57) ABSTRACT

A foldable play yard includes a plurality of corner posts; a plurality of top rails, each of the top rails rotatably connected to two of the plurality of corner posts to define a polygonal shape; a plurality of reversing links, each of the plurality of reversing links rotatably connected to one of the plurality of corner posts; a central hub; a plurality of lower linkage assemblies, each of the lower linkage assemblies rotatably connected to one of the plurality of reversing links and rotatably connected to the central hub; and a plurality of post linkage assemblies, each of the post linkage assemblies rotatably connected to one of more of the top rails and rotatably connected to one of the reversing links. Lowering the central hub causes each of the lower linkage assemblies to rotate relative to the corner posts in a first direction.

### CROSS-REFERENCE TO RELATED APPLICATION

This application claims priority to U.S. Provisional Application Ser. No. 62/778,674, filed Dec. 12, 2018, which application is incorporated by reference herein in its entirety.

### FIELD OF THE INVENTION

The present invention is generally directed to a child play yard and, more particularly, a child play yard that is foldable into a compact position when not in use.

### BACKGROUND OF THE INVENTION

### Description of Related Art

Foldable play yards, playpens, and crib devices are well known, as exemplified, for example, by U.S. Pat. No. 4,811,437 for a “Foldable Playyard” to Dillner et al. The foldable device disclosed therein is light in weight and, when collapsed, a fairly convenient compact package. One major problem with such devices, however, is that they are difficult to handle because they are cumbersome to open and unwieldy to fold with clumsy operating mechanisms. Usually there is a need to pull up on a central lower mechanism and a need to unlatch upper rails also. Another device is shown in an application, U.S. Patent Application Publication No. 2007/0017025, for a “Folding Play Yard” to Myer. There is a purported disclosure of a release mechanism that causes release means such as a cable to unlatch upper side members so that the play yard may go from a deployed to a folded condition. However, there is no disclosure concerning the movement of the play yard from the folded condition to a deployed condition. The release means plays no part in such a movement. Furthermore, the lower structure of the disclosed play yard includes diagonal braces, as well as side members, so that the play yard is complicated and heavy.

Many known play yard designs require complex interconnections of linkages, cables, and/or gear assemblies to obtain the desired qualities of easy operation and compact folding. However, such designs are often expensive to manufacture and require significant calibration during assembly to ensure the play yard folds correctly.

In view of these deficiencies, there exists a need for a play yard that is lightweight and robust while also being easy to operate and efficient to manufacture.

### SUMMARY OF THE INVENTION

The embodiments of the present invention generally are directed to a foldable play yard that has a plurality of corner posts and a plurality of top rails, each of the top rails having two opposing ends, and each of the opposing ends of each of the plurality of top rails rotatably connected to one of the plurality of corner posts to define a polygonal shape The folding play yard of this embodiment also has a plurality of reversing links with each reversing link having a first, second and third connection point, and each of the plurality of reversing links rotatably connected at the second connection point of each reversing link to a corresponding one of the plurality of corner posts. The play yard also has a central hub that moves up and down to aid in opening and closing the play yard. This embodiment of a play yard also has a plurality of lower linkage assemblies, corresponding to the reversing links, with each lower linkage assembly rotatably connected at the first end of each lower linkage assembly to the third connection point of a corresponding reversing link and, at the second end of each lower linkage assembly rotatably connected to the central hub. Additionally, the play yard has a plurality of post linkage assemblies corresponding to the reversing links, with each post linkage assembly having a first and a second end, and each of the plurality of post linkage assemblies rotatably connected at the first end of each post linkage assembly to one or more of the top rails and, at the second end of each post linkage assembly, rotatably connected to the first connection point of an associated or corresponding reversing links. Lowering the central hub causes each of the lower linkage assemblies to rotate relative to the corner posts in a first direction. Rotation of each of the lower linkage assemblies in the first direction causes each of the reversing links to rotate relative to the corner posts in a second direction opposite the first direction. Rotation of the reversing links in the second direction drives the post linkage assemblies to rotate the top rails relative to the corner posts.

In some embodiments, each of the lower linkage assemblies includes a top diagonal link rotatably connected to the central hub and rotatably connected to one of the plurality of corner posts, and a lower diagonal link rotatably connected to the central hub and rotabably connected to one of the plurality of reversing links.

In some embodiments, each of the top diagonal links is rotatably connected to the corner post at the same pivot point as one of the reversing links.

In some embodiments, each of the post linkage assemblies includes a locking link rotatably connected to one or more of the top rails, an actuating link rotatably connected to the locking link, and a lifting link rotatably connected to the actuating link and rotatably connected to one of the reversing links.

In some embodiments, the foldable play yard further includes an anti-racking link rotatably connected to one of the lower linkage assemblies and rotatably connected to one of the post linkage assemblies. The anti-racking link limits rotation of the reversing links.

In some embodiments, the foldable play yard further includes an anti-racking link rotatably connected to the lower diagonal link of one of the lower linkage assemblies and rotatably connected to one of the post linkage assemblies. The anti-racking link limits rotation of the reversing links.

In some embodiments, the foldable play yard further includes an anti-racking link rotatably connected to one of the lower linkage assemblies and rotatably connected to the lifting link of one of the post linkage assemblies. The anti-racking link limits rotation of the reversing links.

In some embodiments, the foldable play yard further includes a guide roller rotatably connected to the actuating link of each post linkage assembly and configured to roll along a guide pad of each of the corner posts. The guide pad of each of the corner posts includes a slanted top surface configured to lock the guide roller in place when the guide roller passes over the slanted top surface.

Other embodiments of the present disclosure are directed to a folding mechanism for a foldable play yard, the foldable play yard including a plurality of corner posts and a plurality of top rails, each of the top rails rotatably connected to two of the plurality of corner posts to define a polygonal shape. The folding mechanism includes a central hub, a reversing link rotatably connected to the central hub via a lower linkage assembly, the reversing link rotatably connected to one of the corner posts, and a post linkage assembly rotatably connected to the reversing link and rotatably connected to at least one of the top rails. Lowering the central hub causes the reversing link to rotate. Rotation of the reversing link causes the post linkage assembly to rotate at least one of the top rails.

In some embodiments, the folding mechanism further includes an anti-racking link rotatably connected to the lower linkage assembly and rotatably connected to the post linkage assembly. The anti-racking link limits rotation of the reversing link.

In some embodiments, the lower linkage assembly includes a top diagonal link rotatably connected to the central hub and rotatably connected to one of the plurality of corner posts, and a lower diagonal link rotatably connected to the central hub and rotatably connected to the reversing link.

In some embodiments, lowering the central hub causes the reversing link to rotate in a direction opposite rotation of the lower linkage assembly.

Other embodiments of the present disclosure are directed to locking mechanism for a foldable play yard, the foldable play yard including a plurality of corner posts and a plurality of top rails, each of the top rails rotatably connected to two of the plurality of corner posts to define a polygonal shape. The locking mechanism includes an actuating link slidably connected to one of the corner posts, a locking link rotatably connected to the actuating link and rotatably connected to one of the top rails, a guide roller rotatably connected to the actuating link, and a guide pad connected to one of the corner posts, the guide pad including a slanted top surface. The guide roller is configured to roll along the guide pad as the actuating link slides relative to the corner post. The top slanted surface of the guide pad is configured to lock the guide roller in place when the guide roller passes over the slanted top surface.

Other embodiments of the present disclosure are directed a locking mechanism for a foldable play yard, the foldable play yard including a plurality of corner posts and a plurality of top rails. The locking mechanism includes an actuating link including a wedge. The actuating link is slidably connected to at least one of the corner posts and rotatably connected to at least one of the top rails adjacent to or corresponding to the corner post. The locking mechanism further includes a locking link rotatably connected to the at least one of the corner posts and rotatably connected to at least one of the top rails adjacent to or corresponding to the corner post. The wedge includes a sliding surface configured to slide along a portion of the corner post as the actuating link slides relative to the corner post. The wedge further includes a locking surface configured to lock in place on the portion of the corner post which the wedge is configured to slide along.

Other embodiments of the present disclosure are directed a locking mechanism for a foldable play yard, the foldable play yard including a plurality of corner posts and a plurality of top rails, each of the top rails rotatably connected to two of the plurality of corner posts to define a polygonal shape. The locking mechanism includes an actuating link slidably connected to one of the corner posts and locking link rotatably connected to the actuating link, rotatably connected to one of the corner posts, and slidable along a camming surface of one of the top rails. The locking link is configured to slide along the camming surface as the actuating link slides relative to the corner post.

In some embodiments, the camming surface includes a locking portion configured to receive the locking link and prevent further sliding of the locking link along the camming surface.

Other embodiments of the present disclosure are directed a locking mechanism for a foldable play yard, the foldable play yard including a plurality of corner posts and a plurality of top rails, each of the top rails rotatably connected to two of the plurality of corner posts to define a polygonal shape. The locking mechanism includes an actuating link slidably connected to one of the corner posts, a locking link rotatably connected to the actuating link and rotatably connected to one of the top rails, one or more rack teeth connected to the corner post, and one or more link teeth projecting from the locking link. The one or more link teeth are configured to engage the one or more rack teeth as the actuating link slides relative to the corner post.

In some embodiments, each of the one or more rack teeth includes a sliding face configured to permit sliding of the one or more link teeth over the sliding face in a first direction, and a locking face configured to prevent sliding of the one or more link teeth over the locking face in a second direction.

In some embodiments, each of the one or more link teeth includes a sliding face configured to permit sliding of the one or more rack teeth over the sliding face in a first direction, and a locking face configured to prevent sliding of the one or more rack teeth over the locking face in a second direction.

Other embodiments of the present disclosure are directed a locking mechanism for a foldable play yard, the foldable play yard including a plurality of corner posts and a plurality of top rails. The locking mechanism includes an actuating slidably connected to one of the corner posts and rotatably connected to one of the top rails, a locking link rotatably connected to one of the corner posts and rotatably connected to one of the top rails, one or more rack teeth connected to the corner post, and one or more link teeth projecting from the actuating link. The one or more link teeth are configured to engage the one or more rack teeth as the actuating link slides relative to the corner post.

In some embodiments, each of the one or more rack teeth includes a sliding face configured to permit sliding of the one or more link teeth over the sliding face in a first direction, and a locking face configured to prevent sliding of the one or more link teeth over the locking face in a second direction.

In some embodiments, each of the one or more link teeth includes a sliding face configured to permit sliding of the one or more rack teeth over the sliding face in a first direction, and a locking face configured to prevent sliding of the one or more rack teeth over the locking face in a second direction.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

For the purpose of facilitating understanding of the invention, the accompanying drawings and description illustrate preferred embodiments thereof, from which the invention, various embodiments of its structures, construction and method of operation, and many advantages, may be understood and appreciated.

FIG. 1 is a top schematic view of a play yard, shown in an unfolded position, according to one embodiment of the present disclosure;

FIG. 2 is a top schematic view of the play yard of FIG. 1, shown in a folded position.

FIG. 3 is a side view of a play yard according to one embodiment of the present disclosure, in the unfolded position;

FIG. 4 is a perspective view of detail A₀ of FIG. 3, showing a foot of the play yard in the unfolded position;

FIG. 5 is a side view of detail A₀ of FIG. 3;

FIG. 6 is a perspective view of detail B₀ of FIG. 3, showing an upper corner of the play yard in the unfolded position;

FIG. 7 is a side view of detail B₀ of FIG. 3;

FIG. 8 is a side view of the play yard of FIG. 3, shown in a first intermediate position;

FIG. 9 is a side view of detail A₁ of FIG. 8, showing the foot of the play yard in the first intermediate position;

FIG. 10 is a side view of detail B₁ of FIG. 8, showing the upper corner of the play yard in the first intermediate position;

FIG. 11 is a side view of the of the play yard of FIG. 3, shown in a second intermediate position;

FIG. 12 is a side view of detail A₂ of FIG. 11, showing the foot of the play yard in the second intermediate position;

FIG. 13 is a side view of detail B₂ of FIG. 11, showing the upper corner of the play yard in the second intermediate position;

FIG. 14 is a side view of the of the play yard of FIG. 3, shown in a folded position;

FIG. 15 is a side view of detail A₃ of FIG. 14, showing the foot of the play yard in the folded position;

FIG. 16 is a side view of detail B₃ of FIG. 14, showing the upper corner of the play yard in the folded position;

FIG. 17 is a side view of the upper corner of the play yard of FIG. 3, just before locking into the unfolded position;

FIG. 18a is a perspective view of an upper corner of the play yard in an unfolded position, according to another embodiment of the present disclosure;

FIG. 18b is the perspective view of FIG. 18a, with a portion of the locking link shown transparently for clarity;

FIG. 19a is a side view of the upper corner of FIG. 18a in the unfolded position;

FIG. 19b is the side of FIG. 19a, with a portion of the locking link removed for clarity;

FIG. 20a is a side view of the upper corner of FIG. 18a in an intermediate position;

FIG. 20b is the side view of FIG. 20a, with a portion of the locking link removed for clarity;

FIG. 21a is a side view of the upper corner of FIG. 18a in a folded position;

FIG. 21b is the side view of FIG. 21a, with a portion of the locking link removed for clarity;

FIG. 22 is a perspective view of an upper corner of the play yard in an unfolded position, according to another embodiment of the present disclosure;

FIG. 23 is a side view of the upper corner of FIG. 22 in the unfolded position;

FIG. 24 is a side view of the upper corner of FIG. 22 in an intermediate position;

FIG. 25 is a side view of the upper corner of FIG. 22 in a folded position;

FIG. 26 is a perspective view of an upper corner of the play yard in an unfolded position, according to another embodiment of the present disclosure;

FIG. 27 is a side view of the upper corner of FIG. 26 in the unfolded position;

FIG. 28a is a side view of the upper corner of FIG. 22 in an intermediate position;

FIG. 28b is the side view of FIG. 28a, with a portion of the upper corner bracket removed for clarity;

FIG. 29a is a side view of the upper corner of FIG. 22 in a folded position;

FIG. 29b is the side view of FIG. 29a, with a portion of the upper corner bracket removed for clarity;

FIG. 30 is a perspective view of an upper corner of the play yard in an unfolded position, according to another aspect of the present disclosure;

FIG. 31 is a side view of the upper corner of FIG. 30 in the unfolded position;

FIG. 32a is a side view of the upper corner of FIG. 30 in an intermediate position;

FIG. 32b is the side view of FIG. 32a, with a portion of the upper corner bracket removed for clarity;

FIG. 33 is a side view of the upper corner of FIG. 30 in a folded position;

FIG. 34a is a perspective view of an upper corner of the play yard in an unfolded position, according to another embodiment of the present disclosure;

FIG. 34b is the perspective view of FIG. 34a, with a portion of the locking link removed for clarity;

FIG. 35a is a side view of the upper corner of FIG. 34a in the unfolded position;

FIG. 35b is the side view of FIG. 35a, with a portion of the locking link removed for clarity;

FIG. 36a is a side view of the upper corner of FIG. 34a in an intermediate position;

FIG. 36b is the side view of FIG. 36a, with a portion of the locking link removed for clarity; and

FIG. 37 is a side view of the upper corner of FIG. 34a in a folded position.

### DETAILED DESCRIPTION OF THE INVENTION

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings and described in the following specification are simply exemplary embodiments of the invention. Hence, specific dimensions and other physical characteristics related to the aspects disclosed herein are not to be considered as limiting.

As used herein, the term “substantially”, when used in the context of defining a first angle relative to a second angle, means that the first angle is within about 5°, and typically no greater than 6°, of the second angle. For example, the term “substantially perpendicular to” means “within about 5° of perpendicular to” or “between about 85° and 95° relative to”. Similarly, the term “substantially parallel to” means “within about 5° of parallel to” or “between about −5° and 5° relative to”. Such definitions are consistent with the commonly-accepted movement of parts of play yards as represented by U.S. Pat. No. 8,756,727 for a Foldable Child Enclosure to Thorne et al. and its related patents and patent applications.

As used herein, the term “pivot”, when used as a noun, means a structural and functional connection between at least two components which allows at least partial rotation of the at least two components relative to one another. For example, a pivot between a first link and a second link means a physical connection between the first link and the second link that permits at least partial rotation of the first link relative to the second link, and vice versa. The pivot may include a hole in one or both of the first and second links, and an axial member extending through the hole(s) to constrain the first and second links to each other about a rotational axis. The axial member may include a pin, bolt, screw, bearing, bushing, or combination thereof to facilitate rotation of the first and second links relative to each other.

The present disclosure and embodiments of the present invention are generally directed to a child play yard and, more particularly, a child play yard that is foldable into a compact position when not in use.

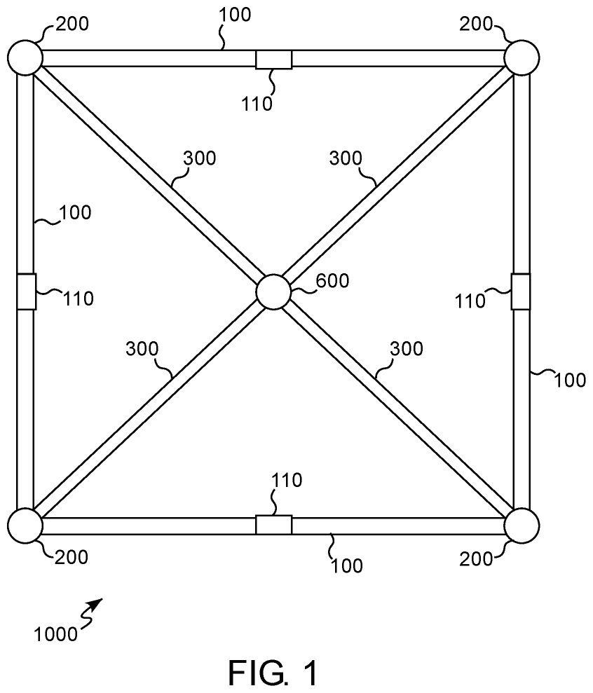

FIG. 1 shows a top schematic view of a play yard 1000 according to one embodiment of the present disclosure. The play yard 1000 is shown in an unfolded position, ready for use. The play yard 1000 includes a plurality of top rails 100 connected to a plurality of corner posts 200 to define a polygonal shape, such as a rectangle as shown. The top rails 100 are connected to upper ends of the corner posts 200, with each of the corner posts 200 connected to two of the top rails 100. Each top rail 100 includes a joint member 110 which allows the top rail 100 to fold such that the pair of corner posts 200 connected to the top rail 100 are brought toward each other.

With continued reference to FIG. 1, a lower end of each of the corner posts 200 is connected to one of a plurality of lower linkage assemblies 300. Each of the lower linkage assemblies 300 is connected to a central hub 600, located substantially equidistant from each of the corner posts 200. The plurality of lower linkage assemblies 300, corresponding to the reversing links 260, are pivotally connected to the corner posts 200 and the central hub 600 such that the corner posts 200 may be drawn together by rotation of the lower linkage assemblies 300.

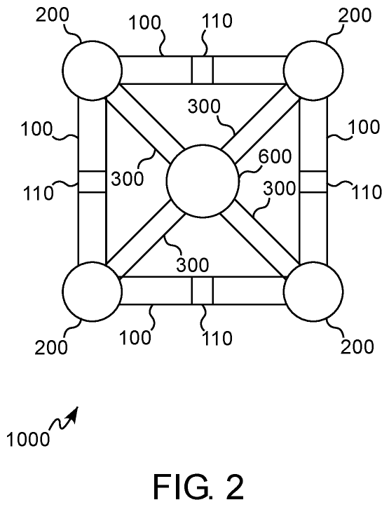

While FIGS. 1-2 show the play yard 1000 having four sides, one side corresponding to each of the top rails 100, the play yard 1000 may have more or fewer sides without departing from the scope of the invention. Generally, the number of sides of the play yard 1000 will be equal to the number of top rails 100 and equal to the number of lower linkage assemblies 300. For example, a three-sided or triangular play yard 1000 may have three top rails 100 and three lower linkage assemblies 300, a five-sided or pentagonal play yard 1000 may have five top rails 100 and five lower linkage assemblies 300, and a six-sided or hexagonal play yard 1000 may have six top rails 100 and six lower linkage assemblies 300. Moreover, while FIGS. 1 and 2 show a square play yard 1000 with sides of equal length, other embodiments of the play yard 1000 may have sides of different lengths.

To transition the play yard 1000 from the unfolded position shown in FIG. 1 to a folded position for storage, shown in FIG. 2, a user may raise the central hub 600 thereby decreasing the angle between each of the lower linkage assemblies 300 and the connected corner posts 200. The lower linkage assemblies 300 are operatively connected to the top rails 100 such that each the top rails 100 folds at the joint member 110 as the central hub 600 is raised. As such, raising the central hub 600 causes the corner posts 200 to be drawn together toward each other and toward the central hub 600, as shown in FIG. 2. To transition the play yard 1000 from the folded position to the unfolded position, the central hub 600 is lowered, causing the lower linkage assemblies 300 to rotate away from the corner posts 200 and the top rails 100 to unfold.

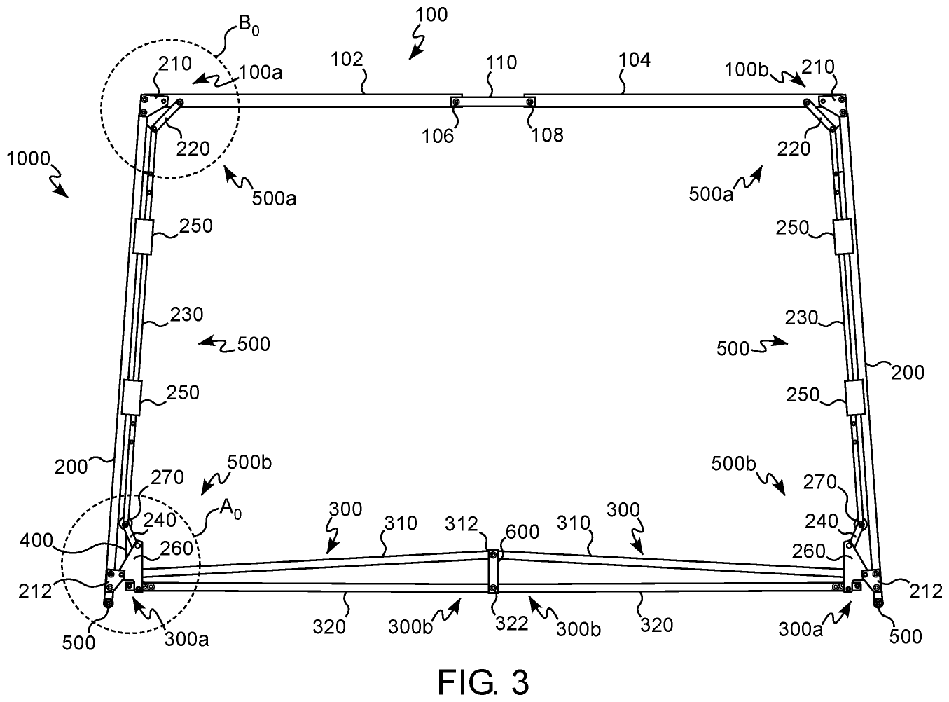

Not depicted in FIGS. 1 and 2, for clarity, are the sidewalls and floor of the play yard 1000, which may be made of fabric, mesh, and/or similar pliable materials. Additionally, the top rails 100, corner posts 200, and lower linkage assemblies 300 are shown schematically as single, monolithic elements. However, each of the top rails 100, the corner posts 200, and the lower linkage assemblies 300 may include one or more interconnected members, as shown in greater detail with reference to FIGS. 3 through 17. Also in FIGS. 1 and 2, the corner posts 200 are generally depicted as extending substantially parallel to a vertical axis and substantially parallel to one another, for simplicity. However, as will become apparent from FIGS. 3 through 17, the corner posts 200 may each be inclined inwardly or outwardly relative to the vertical axis and the central hub 600 while remaining substantially parallel. Furthermore, the corner posts 200 may change inclination with respect to the vertical axis as the play yard 1000 is transitioned from the unfolded position to the folded position, and vice versa.

Transitioning of the play yard 1000 between the unfolded and folded positions will now be described in greater detail with reference to FIGS. 3 through 17, which for simplicity show only one side of the play yard 1000.

Referring now to FIG. 3, one side of the play yard 1000 is shown in the unfolded state with the top rail 100, having two opposing ends 100a and 100b, substantially straight across and the joint member 110 in an extended position. The top rail may include a left member 102 and a right member 104 rotatably connected to the joint member 110 at respective pivot points 106, 108. In some embodiments, the left and right members 102, 104 of the top rail 100 may be rotatably connected directly to each other, with the joint member 110 omitted. However, inclusion of the joint member 110 having two pivot points 106, 108 corresponding to the left and right members 102, 104 provides a safety feature in that the joint member 110 can bend in a compound manner to deflect around a user's or child's body part located underneath the joint member 110. As such, the risk of crushing or trapping the user's or child's body part is reduced by the presence of the joint member 110.

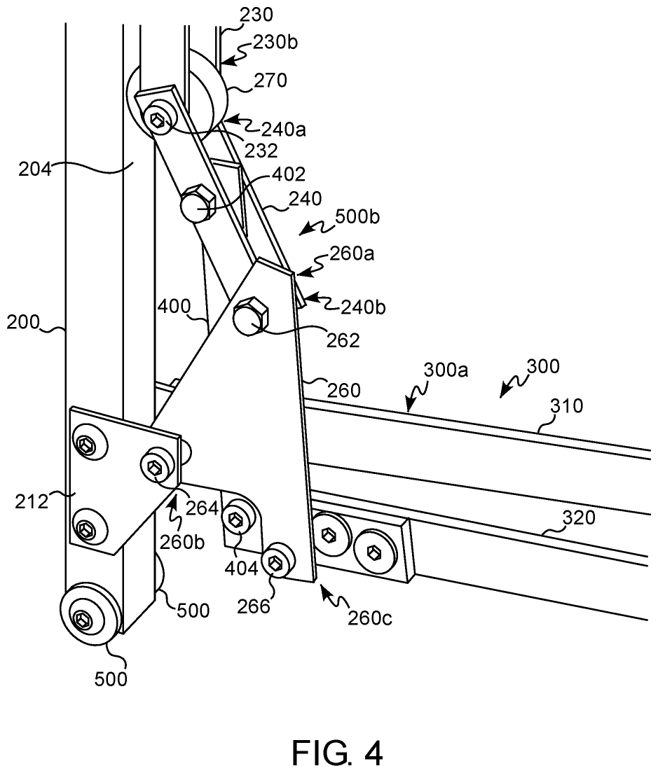

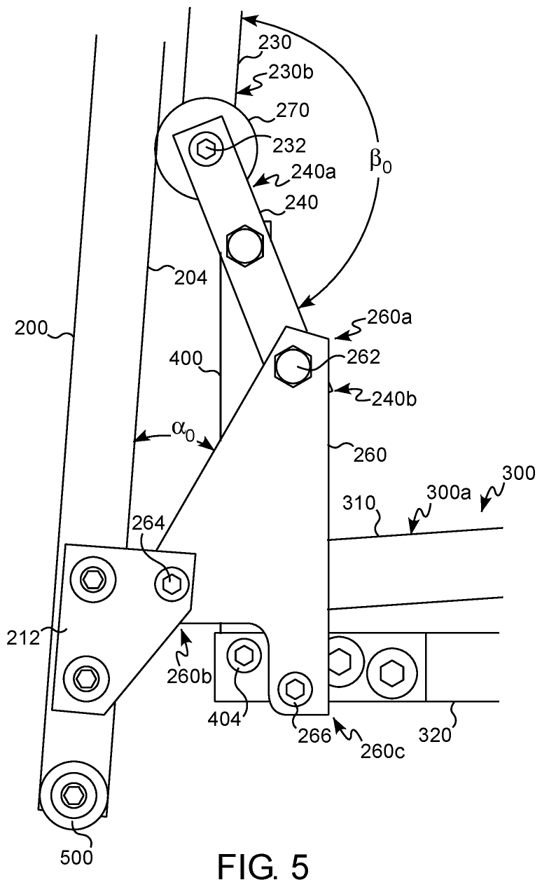

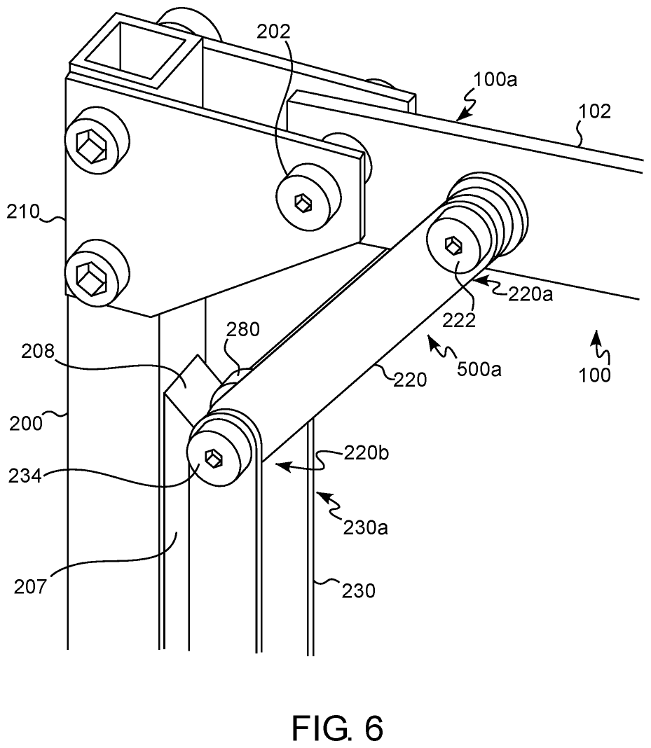

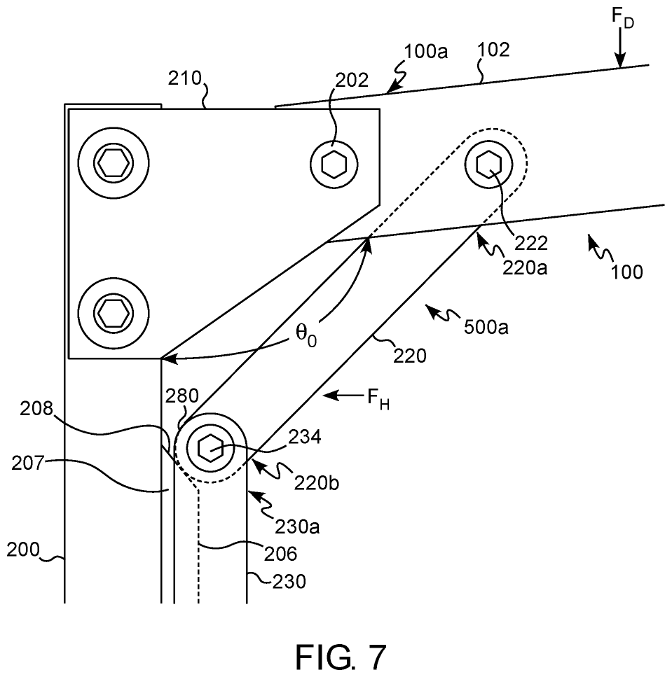

As shown in detail in FIG. 6, the opposing ends 100a and 100b of the left and right members 102, 104 of the top rail 100 opposite the joint member 110 are rotabably connected to opposing corner posts 200 at upper corner pivots 202. Each upper corner pivot 202 may be located on an upper corner bracket 210 extending from the corner post 200 and offsetting the upper corner pivot 202 from the longitudinal axis of the corner post 200. Each of the left and right members 102, 104 of the top rail 100 are also rotatably connected to a first end of a locking link 220. Each locking link 220 has a first end 220a and a second end 220b and is rotatable relative to the corresponding left or right member 102, 104 of the top rail 100 about a locking link pivot 222 located along the corresponding left or right member 102, 104 between the upper corner pivot 202 and the joint 110. The second end 220b of each locking link 220 opposite the connection to the top rail 100 is connected to a first end 230a of an actuating link 230 generally extending along or beside the corner post 200 (as shown in FIGS. 3 through 8). As shown in FIGS. 6 and 7, the locking link 220 and the actuating link 230 are connected to each other at an upper actuating link pivot 234 that permits rotation of the locking link 220 relative to the actuating link 230. As shown in FIGS. 4 and 5, a second end 230b of the actuating link 230 opposite the connection to the locking link 220 is connected to a first end 240a of a lifting link 240. The actuating link 230 and the lifting link 240 are connected to each other at a lower actuating link pivot 232 that permits rotation of the lifting link 240 relative to the actuating link 230. Collectively, the locking link 220, the actuating link 230, and the lifting link 240 may hereinafter be referred to as the post linkage assembly 500.

Each corner post 200 may include one or more guide channels 250 extending around the actuating link 230 to limit or prevent movement of the actuating link 230 in a direction perpendicular to the longitudinal axis of the corner post 200. The one or more guide channels 250 permit translation or sliding of the actuating link 230 in a direction generally parallel to the longitudinal axis of the corner post 200. As such, the locations of the upper and lower actuating link pivots 234, 232 relative to the corner post 200 may be changed by sliding the actuating link 230 generally parallel to the longitudinal axis of the corner post 200. In some embodiments of the present invention, the one or more guide channels 250 may extend from the corner post 200, as is shown in the accompanying drawings. In other embodiments of the present invention, the one or more guide channels 250 may be defined by a cavity in a cover or shroud surrounding the corner post 200.

As shown in FIGS. 4 and 5, a second end 240b of the lifting link 240 opposite the connection to the actuating link 230 is rotatably connected to a reversing link 260. The reversing link 260 has a first connection point 260a, a second connection point 260b and a third connection point 260c. The second end 240b of the lifting link 240 is rotatably connected to the first connection point 260a of an associated or corresponding reversing link 260, which connection, in some embodiments, is a lifting link pivot 262. An associated reversing link 260 is also rotatable connected to the corresponding corner post 200 at the second connection point 260b of the reversing link 260 and is rotatably connected to the lower linkage assembly 300 at the third connection point 260c of the reversing link 260. The reversing link 260 is connected to the corner post 200 at a reversing link pivot 264 which may be located on a lower corner bracket 212 to offset the reversing link pivot 264 from the longitudinal axis of the corner post 200. The reversing link 260 is further connected to the lower linkage assembly 300 at two locations.

Each lower linkage assembly 300 will have a first end 300a where the lower linkage assembly 300 connects to a corresponding corner post 200 and a second end 300b where the lower linkage assembly 300 connects to the central hub 600. As may be appreciated from FIG. 3, the lower linkage assembly 300 may include an upper diagonal link 310 and a lower diagonal link 320. The upper diagonal link 310 may be connected to the reversing link 260 and the corner post 200 at the reversing link pivot 264 such that the reversing link 260 and the lower diagonal link 320 may rotate relative to each other and relative to the corner post 200. The lower diagonal link 320 may be connected to the reversing link 260 at a lower link pivot 266 such that the lower diagonal link 320 may rotate relative to the reversing link 260. An end of the upper diagonal link 310 opposite the connection to the reversing link 260 and the corner post 200 is rotatably connected to the central hub 600 at an upper hub pivot 312. Similarly, the lower diagonal link 320 opposite the connection to the reversing link 260 is rotatably connected to the central hub 600 at a lower hub pivot 322.

Referring now to FIGS. 4 and 5, the foot portion of the play yard 1000 shown in detail A₀ of FIG. 3 will now be described in greater detail. The actuating link 230 may include a lower guide roller 270 rotatably connected to the actuating link 230 and configured to roll along a lower bearing surface 204 of the corner post 200 as the actuating link 230 is slid relative to the corresponding corner post 200. As shown in FIGS. 4 and 5, the lower guide roller 270 may be connected to the actuating link 230 at the lower actuating link pivot 232, such that the lower actuating link pivot 232 serves as both the connection between the actuating link 230 and the lifting link 240 and as a rotational axis of the lower guide roller 270. In other embodiments of the present invention, the lower guide roller 270 may be connected at any location along the actuating link 230 on either side of the lower actuating link pivot 234.

With continued reference to FIGS. 4 and 5, some embodiments of the present invention may optionally include an anti-racking link 400 connecting the lifting link 240 to the lower linkage assembly 300. The anti-racking link 400 has a first end rotatably connected to the lifting link 240 at an upper anti-racking pivot 402. Further, the anti-racking link 400 has a second end rotatably connected to the lower diagonal link 320 of the lower linkage assembly 300 at a lower anti-racking pivot 404. The upper anti-racking pivot 402 may be located along the lifting link 240 between the lower actuating link pivot 232 and the lifting link pivot 262. The lower anti-racking pivot 404 may be located on lower diagonal link 320 of the lower linkage assembly 300 at a location between the lower link pivot 266 and the corner post 200. The function of the anti-racking link 400 is to control movement of the lower assembly 300 relative to the lifting link 240 as the actuating link 230 is slid relative to the corner post 200. This, in turn, prevents over-rotation of the reversing link 260 relative to the corner post 200 during folding and unfolding of the play yard 1000. It is contemplated that this functionality could be achieved with the upper and lower anti-racking pivots 402, 404 located on different components of the play yard 1000 without departing from the scope of the present disclosure. For example, in other aspects of the present disclosure, the lower anti-racking pivot 404 may be located on the upper diagonal link 310 of the lower linkage assembly 300.

It is noted that the anti-racking link 400 needs to be provided on only one of the lower linkage assemblies 300 of the play yard 1000 to achieve the functionality discussed above. Because all of the top rails 100, corner posts 200, and lower linkage assemblies 300 of the play yard 1000 are ultimately interconnected, preventing over-rotation of the reversing links 260 associated with only one of the corner posts 200 inherently prevents over-rotation of the reversing links 260 associated with the other corner posts 200. However, in some aspects of the present disclosure, the anti-racking link 400 may be provided on multiple or all of the lower linkage assemblies 300 associated with multiple or all of the corner posts 200.

Also shown in FIG. 4, the play yard 1000 may include one or more wheels 500 rotatably connected to the bottom of each corner post 200. The wheels 500 allow the corner posts 200 to roll along a floor surface as the play yard 1000 is transitioned from the unfolded position to the folded position and vice versa. Additionally, the wheels may assist a user in moving the play yard 1000 across the floor surface.

In the unfolded position as shown in FIGS. 3 through 5, each reversing link 260 is at a minimum rotation angle α₀ relative to the corner post 200. As such, the lifting link pivot 262 is at its closest position relative to the corner post 200, which in turn maximizes the rotation angle β₀ of the lifting link 240 relative to the actuating link 230. Consequently, the actuating link 230 is slid to an upward-most position relative to the corner post 200.

Referring now to FIGS. 6 and 7, a top corner portion of the play yard 1000 shown in detail B₀ of FIG. 3 will be described in greater detail. It is noted that the perspective view of FIG. 6, for simplicity, shows only one top rail 100, including the left member 102. However, the play yard 1000 would include a second top rail 100 connected to the corner post 200 in the same manner as the top rail 100 shown. The second top rail 100 would be located about the longitudinal axis of the corner post 200 at an angle relative to the top rail 100 shown. For example, in the aspect of the play yard 100 shown in FIGS. 1 and 2, the second top rail 100 would extend from the corner post 200 at a 90° angle relative to the top rail 100 shown in FIG. 6.

As shown in FIGS. 6 and 7, the actuating link 230 may include an upper guide roller 280 rotatably connected to the actuating link 230 and configured to roll along an upper bearing surface 206 of the corner post 200. The upper guide roller 280 may be connected to the actuating link 230 at the upper actuating link pivot 234, such that the upper actuating link pivot 234 serves as both the connection between the actuating link 230 and the locking link 220 and as a rotational axis of the upper guide roller 280. In other aspects of the present disclosure, the upper guide roller 280 may be connected at any location along the actuating link 230 on either side of the upper actuating link pivot 234.

In some embodiments of the present invention, as shown in FIGS. 6 and 7, the upper bearing surface 206 may include a guide pad 207 extending outwardly from the corner post 200. The guide pad 207 may include a slanted top surface 208 which serves as a lock to retain the play yard 1000 in the unfolded position and prevent unintentional transition to the folded position due to a force applied to the top rail 100. In particular, the upper guide roller 280 rests on the slanted top surface 208 with the play yard 1000 in the unfolded position. Alternatively, the upper guide roller 280 passes over the slanted top surface 208 as the play yard 1000 is transitioned to the unfolded position. In either case, the upper guide roller 280 becomes locked or trapped by the slanted top surface 208 against any downward forces imparted to the top rail 100. If a downward force F_{D} is imparted to top rail 100, such as by a child climbing on the top rail 100, the downward force is transmitted through the locking link 220. Due to the angle of the locking link 220 relative to the top rail 100 and the corner post 200, a component of the downward force F_{D} is redirected into a horizontal force F_{H} acting through the upper guide roller 280 against the corner post 200. The horizontal force F_{H} prevents the guide roller 280 from traveling back along the slanted top surface 208 of the guide pad 207.

With continued reference to FIGS. 3, 6 and 7 showing the play yard 1000 in the unfolded position, the top rail 100 is rotated relative to the corner post 200 at a maximum rotation angle θ₀. As discussed above with respect to FIGS. 3 through 5, the rotational position of the reversing link 260 in the unfolded position of the play yard 1000 drives the actuating link 230 to an upward-most position relative to the corner post 200. Consequently, the actuating link 230 drives the locking link 220 upward which in turn drives the top rail 100 to the maximum rotation angle θ₀.

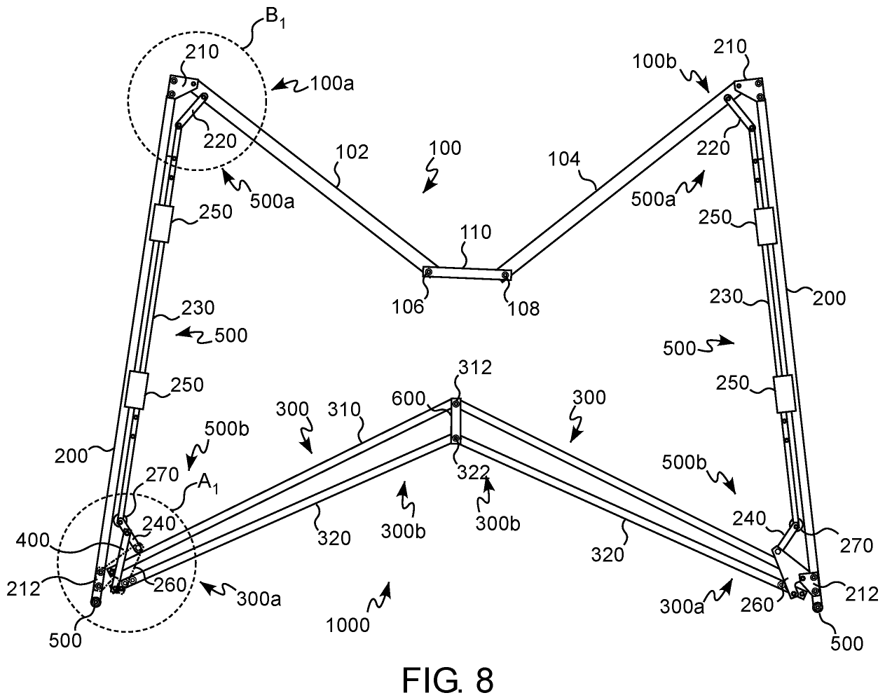

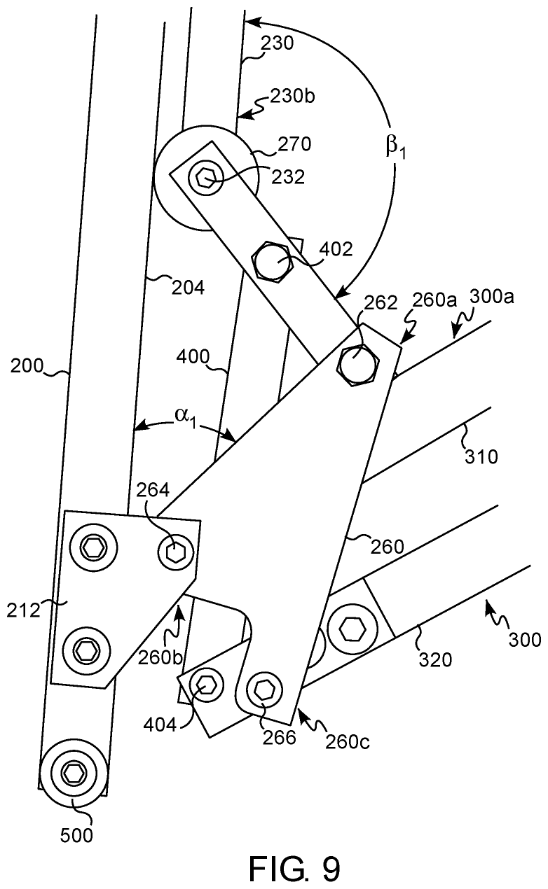

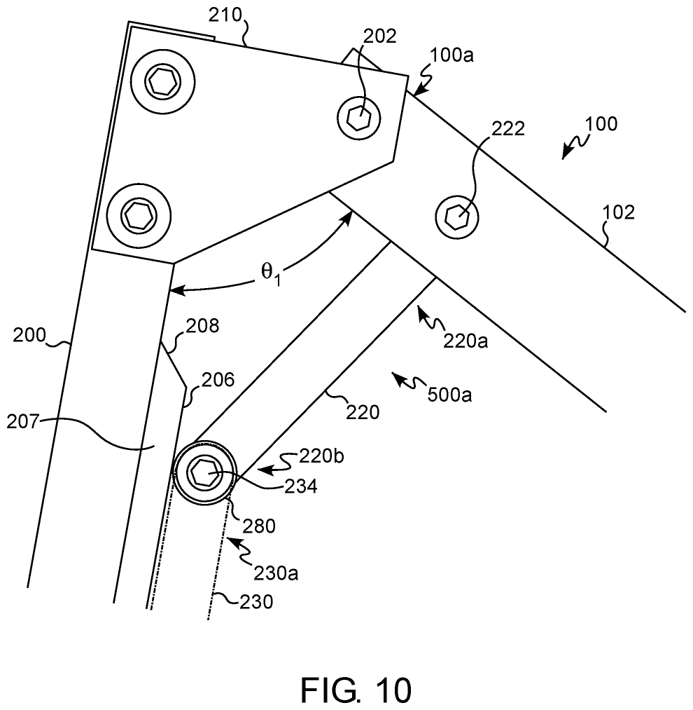

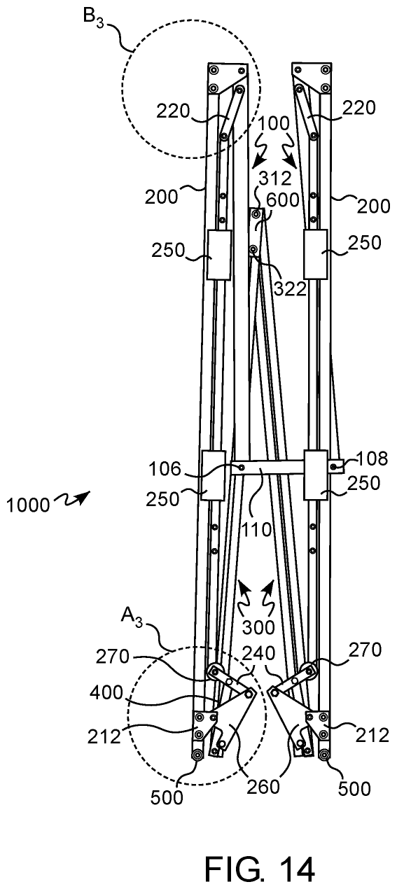

Referring now to FIG. 8, one side of the play yard 1000 is shown in a first intermediate position between the unfolded position of FIG. 3 and the folded position of FIG. 14. FIG. 9 shows the foot portion of the play yard 1000 from detail A₁ of FIG. 8, and FIG. 10 shows the upper corner portion of the play yard 1000 from detail B₁ of FIG. 8. The play yard 1000 is transitioned from the unfolded position to the first intermediate position by a user raising the central hub 600. As the central hub 600 is raised, the lower linkage assemblies 300 are rotated upward, the top rail 100 pivots about the joint member 110, and the corner posts 200 are drawing toward the central hub 600. As may be appreciated from FIG. 8, the left and right members 102, 104 of the top rails 100 may rotate freely about the pivot points 106, 108 of the joint member 110 such that the top rail 100 has multiple degrees of freedom when folding to prevent pinning a user's or child's body part under the top rail 100.

Referring now to FIGS. 8 and 9, raising the central hub 600 causes the end of the lower linkage assembly 300 connected to the central hub 600 to be raised relative to the end of the lower linkage assembly 300 connected to the reversing link 260 and the corner post 200. Due to the arrangement of the upper diagonal link 310 and the lower diagonal link 320 of the lower linkage assemblies 300, raising the central hub 600 causes the lower diagonal link 320 to push the lower link pivot 266 toward the corner post 200. As such, the reversing link 260 is rotated about the reversing link pivot 264 in a direction that moves the lower link pivot 266 toward the corner post 200 and moves the lifting link pivot 262 away from the corner post 200. In the orientation of the play yard 1000 shown in FIG. 9, the reversing link 260 is rotated in a clockwise direction relative to the position of the reversing link 260 in the unfolded position shown in FIG. 5. Accordingly, the angle α₁ of the reversing link 260 relative to the corner post 200 with the play yard 1000 in the first intermediate position is greater the minimum angle α₀ of the reversing link 260 relative to the corner post 200 with the play yard 1000 in the unfolded position (as shown in FIG. 5).

As may also be appreciated from FIG. 9, rotation of the reversing link 260 occurs in the opposite direction of rotation of the lower linkage assembly 300. As noted above, the reversing link 260 is rotated in a clockwise direction when viewed in the orientation of the play yard 1000 shown in FIG. 9. In contrast, the lower linkage assembly 300, when viewed in the orientation of the play yard 1000 shown in FIG. 9, rotates about the reversing link pivot 264 in a counterclockwise direction.

With continued reference to FIG. 9, the increase in the angle α₁ of the reversing link 260 relative to the corner post 200 pulls the lifting link pivot 262 away from the corner post 200, which in turn decreases the rotation angle β₁ of the lifting link 240 relative to the actuating link 230. Consequently, the actuating link 230 is slid downward relative to the corner post 200.

Referring now to FIG. 10, as the actuating link 230 is slid downward relative to the corner post 200, the upper guide roller 280 is pulled over the top slanted surface 208 of the guide pad 207 and out to the locked position. The locking link 220 is pulled down along with the actuating link 230 such that the left member 102 of the top rail 100 is rotated about the upper corner pivot 202. The rotation angle θ₁ of the top rail 100 relative to the corner post 200 is decreased compared to the maximum angle θ₀ as shown in FIG. 7.

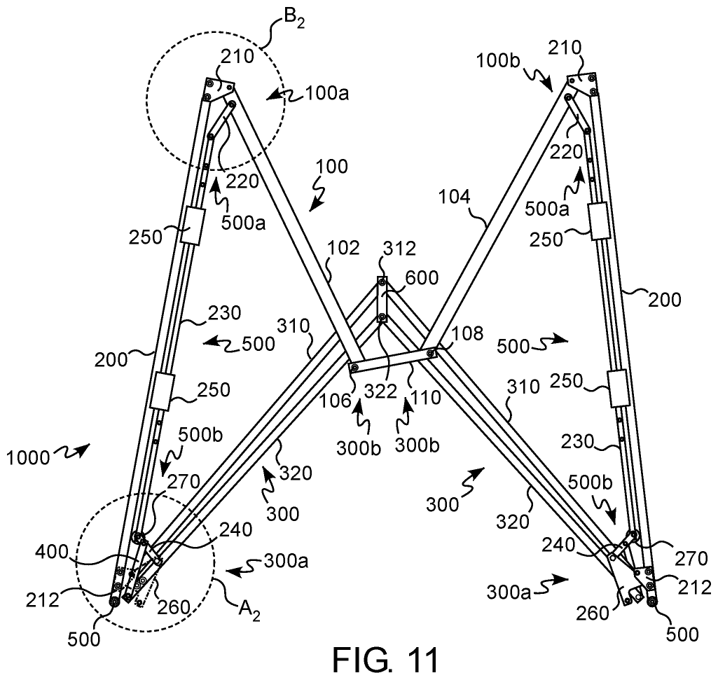

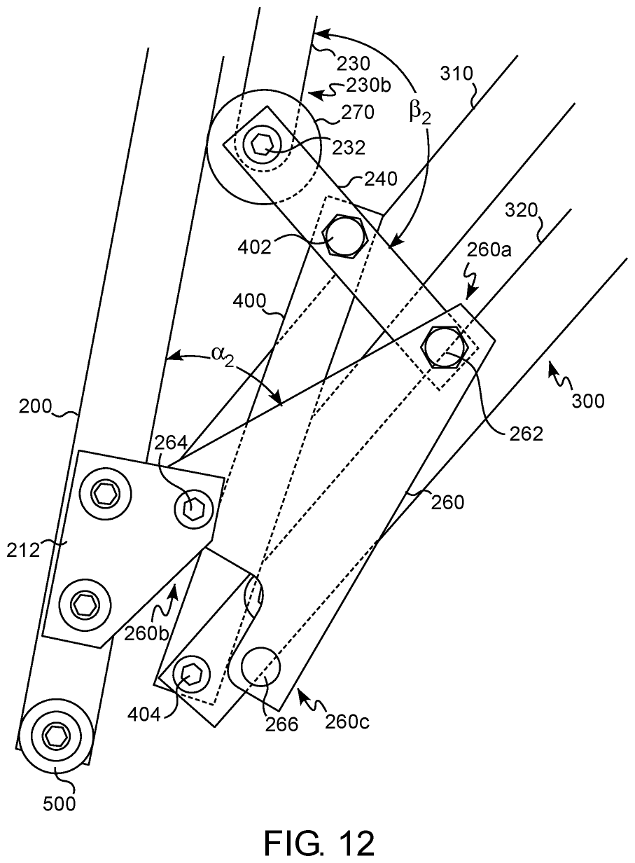

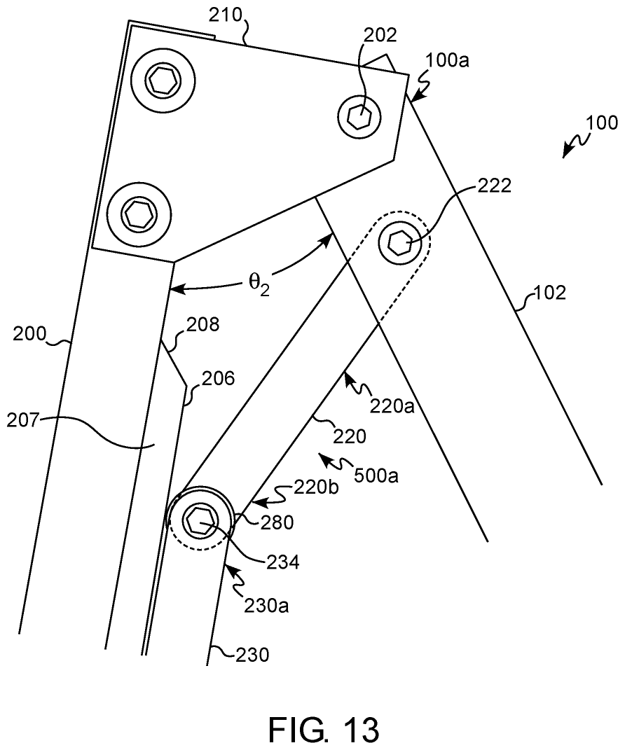

Referring now to FIG. 11, one side of the play yard 1000 is shown in a second intermediate position between the first intermediate position of FIG. 8 and the folded position of FIG. 14. FIG. 12 shows the foot portion of the play yard 1000 from detail A₂ of FIG. 11, and FIG. 13 shows the upper corner portion of the play yard 1000 from detail B₂ of FIG. 11. The play yard 1000 is transitioned from the first intermediate position to the second intermediate position by the user further raising the central hub 600. The action of the various components as the play yard 1000 is transitioned from the first intermediate position to the second intermediate position is generally a continuation of the action of the play yard 1000 transitioning from the unfolded position to the first intermediate position (as described above with reference to FIGS. 8 through 10). As the central hub 600 is further raised to the second intermediate position, the reversing link 260 continues to rotate about the reversing plate pivot 264, increasing the rotation angle α_{z} relative to the rotation angle α₁ of the first intermediate position. The rotation angle β₂ between the actuating link 230 and the lifting link 240 continues to decrease relative to the rotation angle β₁ of the first intermediate position. As a result, the actuating link 230 is drawn further downward relative to the corner post 200, in turn pulling the locking link 220 and top rail 100 closer to the corner post 200. Consequently, the rotation angle θ₂ between the top rail 100 and the corner post 200 continues to decrease relative to the rotation angle θ₁ of the first intermediate position. The corner posts 200 are therefore drawn closer to the central hub 600.

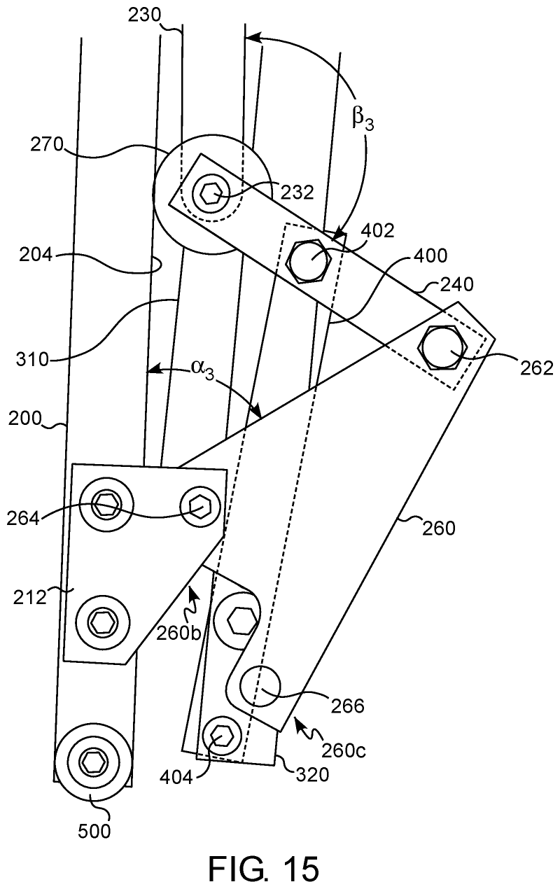

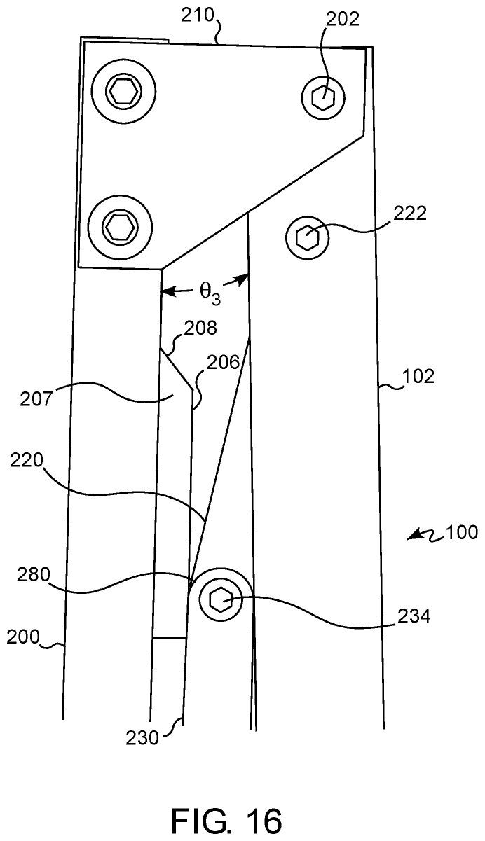

Referring now to FIG. 14, one side of the play yard 1000 is shown in the folded position of FIG. 14. FIG. 15 shows the foot portion of the play yard 1000 from detail A₃ of FIG. 14, and FIG. 16 shows the upper corner portion of the play yard 1000 from detail B₃ of FIG. 14. The play yard 1000 is transitioned from the second intermediate position to the folded position by the user further raising the central hub 600. The action of the various components as the play yard 1000 is transitioned from the second intermediate position to the folded position is generally a continuation of the action of the play yard 1000 transitioning from the first intermediate position to the second intermediate position (as described above with reference to FIGS. 11 through 13). As the central hub 600 is further raised to the folded position, the reversing link 260 continues to rotate about the reversing plate pivot 264, increasing the rotation angle α₃ relative to the rotation angle α₂ of the second intermediate position. The rotation angle β₃ between the actuating link 230 and the lifting link 240 continues to decrease relative to the rotation angle β₂ of the second intermediate position. As a result, the actuating link 230 is drawn further downward relative to the corner post 200, in turn pulling the locking link 220 and top rail 100 closer to the corner post 200. Consequently, the rotation angle θ₃ between the top rail 100 and the corner post 200 continues to decrease relative to the rotation angle θ₂ of the second intermediate position. The corner posts 200 are therefore drawn closer to the central hub 600.

Throughout the movement of the various components of the play yard 1000 from the unfolded position to the first intermediate position, the second intermediate position, and ultimately the folded position, the anti-racking link 400 limits the rotation of the reversing link 260 to prevent over-rotation of the reversing link 260. As such, the lifting link pivot 262 is maintained on an inward side of the corner post 200 relative to the central hub 600, and the relative rotation between the corner posts 200 and the lower linkage assemblies 300 is limited to a range suitable for smooth folding and unfolding of the play yard 1000.

The play yard 1000 may be transitioned from the folded position of FIGS. 14 through 16 back to the unfolded position of FIGS. 3 through 7 by the user pressing down on the central hub 600. As the user presses down on the central hub 600, the action of the various components of the play yard 1000 is simply the opposite of the action described above for transitioning the play yard from the unfolded position to the folded position. In particular, as the play yard is transitioned from the folded position to the unfolded position, pressing down on the central hub 600 causes the reversing link 260 to rotate, which ultimately drives the actuating link 230 upward relative to the corner posts 200 and locks the top rails 100 in the unfolded position.

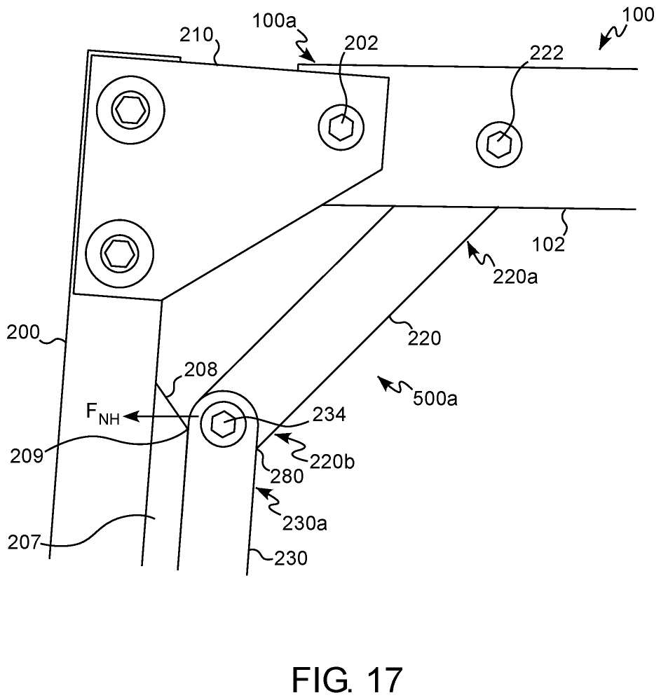

Referring now to FIG. 17, an upper corner portion of the play yard 1000 is shown during the transition from the first intermediate position to the unfolded position, just prior to the upper guide roller 280 being locked into place. The upper guide roller 280 rolls along the guide pad 207 and begins to crest a corner 209 of the guide pad 207 onto the top slanted surface 208. As the actuating link 230 presses upward into the locking link 220, the locking link 220 exerts a normal force against the actuating link 230 at the upper actuating link pivot 234. A horizontal component of the normal force F_{NH} presses the upper guide roller 280 against the corner post 200 and prevents the upper guide roller 280 from rolling back down the top slanted surface 208. In this manner, the actuating link 230 and the locking link 220 are retained in the unfolded position until the central hub 600 is raised to relieve the normal force exerted by the locking link 220 on the actuating link 230.

The post linkage assembly 500 has a first end 500a and a second end 500b as shown in FIG. 3. In the embodiments of the present invention described above, the post linkage assembly 500 includes three members, namely the locking link 220, the actuating link 230, and the lifting link 240. In other embodiments, the post linkage assembly 500 may include more or fewer members without departing from the scope of the present disclosure. For example, the post linkage assembly 500 may include only two members while still maintaining the functionality described above of the locking link 220, the actuating link 230, and the lifting link 240. More generally, the post linkage assembly 500 may include a combination of any number of members which is rotatably connected to the top rail 100 and rotatably connected to the reversing link 260 such that raising the central hub 600 transitions the top rail 100 toward the folded position, and lowering the central hub 600 transitions the top rail 100 toward the unfolded position.

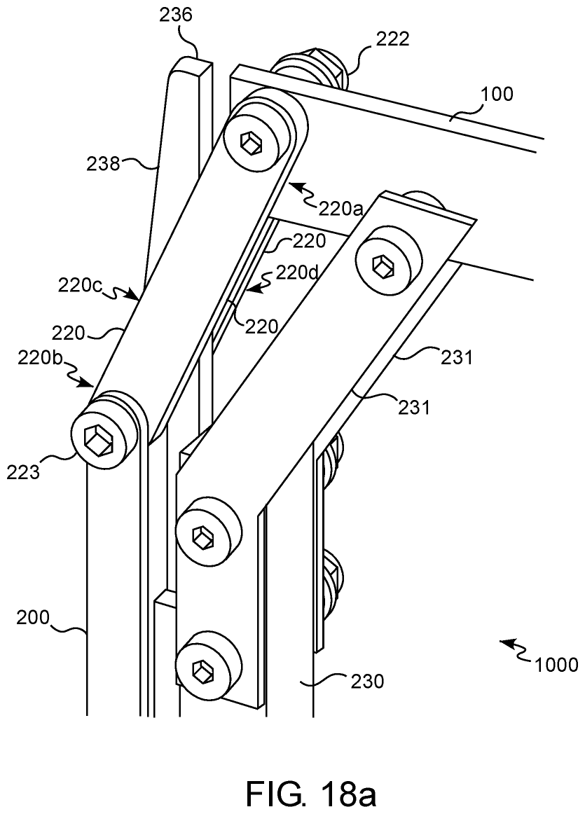

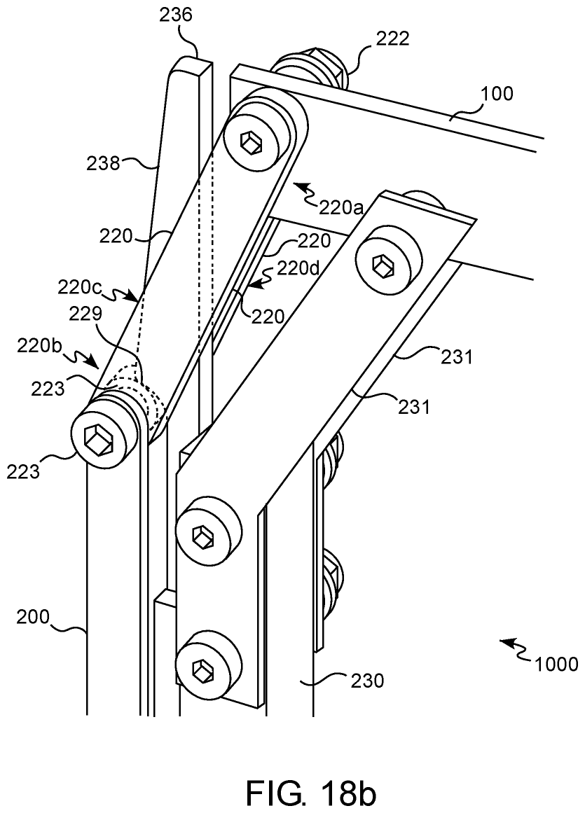

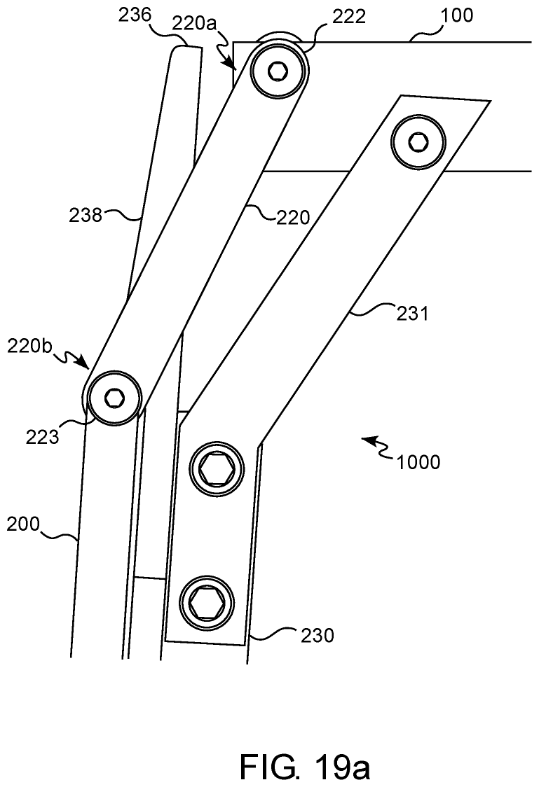

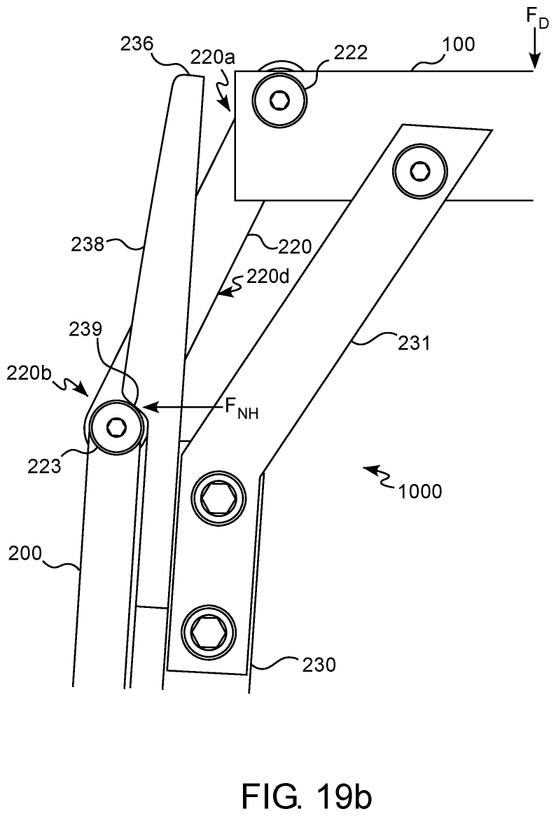

Referring now to FIGS. 18a through 37, other embodiments of the present invention may include alternative arrangements for locking the play yard 1000 into the unfolded position to prevent unintentional transition to the folded position from, for example, a downward force F_{D} applied to the top rail 100. As many of the components of the embodiments shown in FIGS. 18a through 37 are the same or similar to the components of the aspects of FIGS. 3 through 17, only the differences will be discussed in detail. In one embodiment, shown in FIGS. 18a through 21b, the second end 220b of the locking link 220 may be rotatably connected to the corner post 200 via a pivot element 223, rather than connected to the actuating link 230 as in the aspect of FIGS. 3 through 17. The actuating link 230 may be rotatably connected to the top rail 100 via an actuating link extension 231 rigidly connected to the actuating link 230. The actuating link extension 231 is rotatably connected to the top rail 100 at location between the joint member 110 (see FIGS. 1 and 2) and the connection of the locking link 220 to the top rail 100. As may be appreciated from FIGS. 18a and 18b, the locking link 220 may include two separate members 220c and 220d arranged on opposite sides of the corner post 200 and the top rail 100 to stabilize and facilitate the range of the motion of the top rail 100 and locking link 200. In FIG. 18b, the member of the locking link in the foreground 220c is shown transparently so as to clearly show other components of the play yard 1000. In FIGS. 19b, 20b and 21b, the member of the locking link 220c in the foreground is omitted so as to clearly show other components of the play yard 1000.

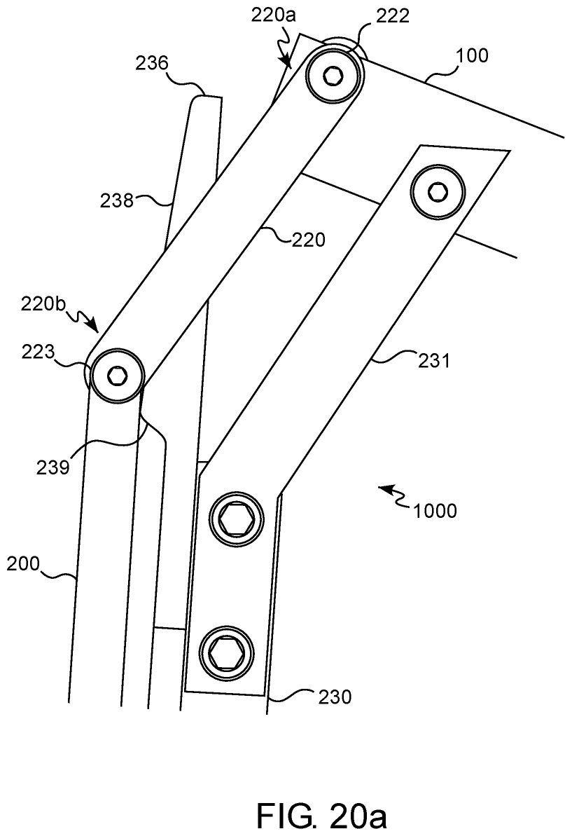

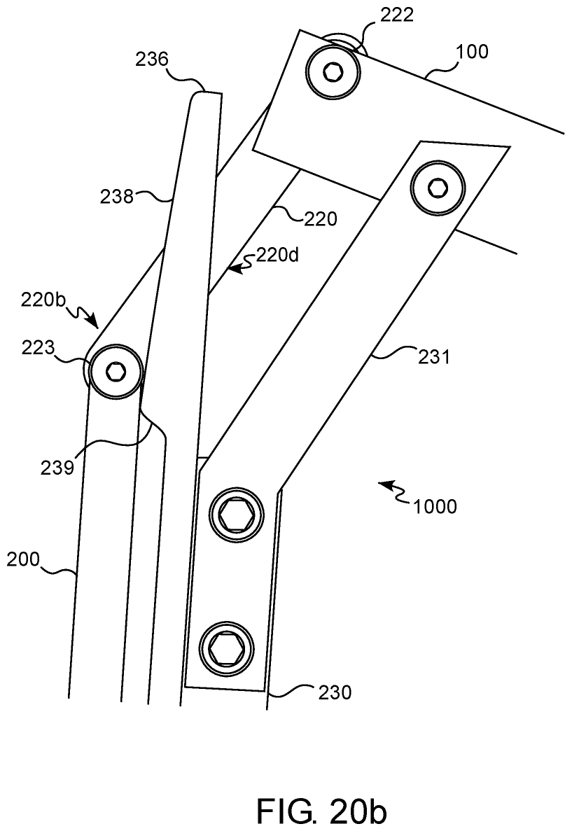

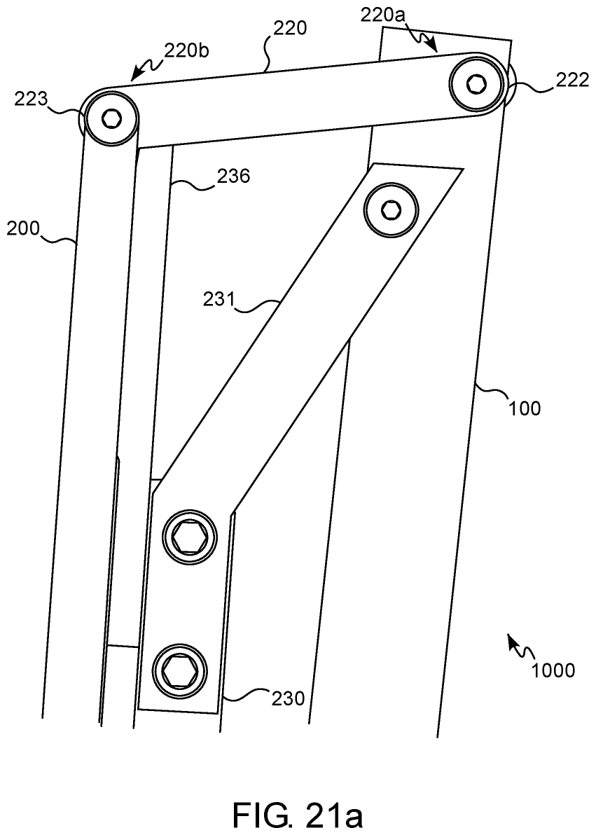

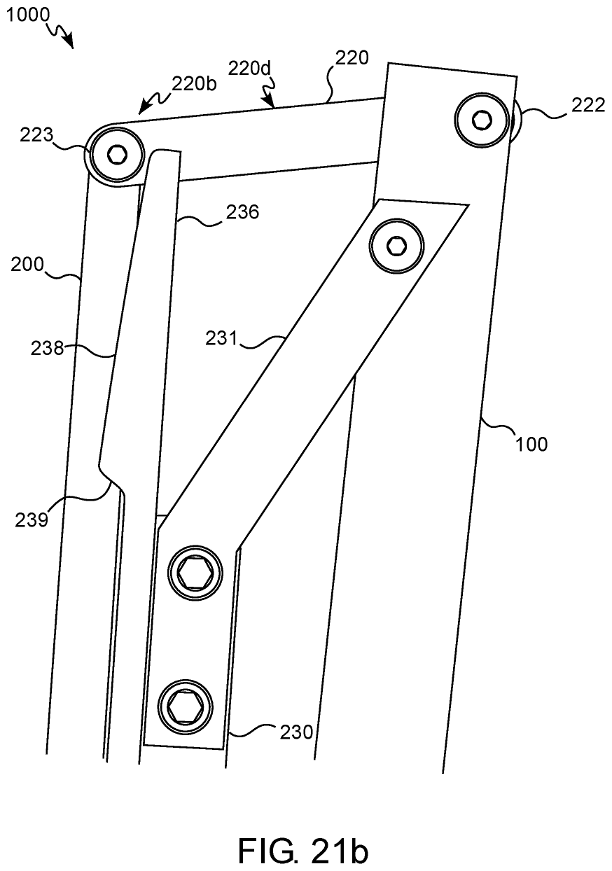

With continued reference to FIGS. 18a through 21b, a wedge 236 may be affixed to or integral with the actuating link 230. The wedge 236 includes a guide surface 238 configured to slide along a portion of the corner post 200 as the actuating linking 230 moves upwards relative to the corner post 200. For example, the guide surface 238 of the wedge 236 may slide along a pin, bearing, or other pivot element 223 connecting the locking link 220 to the corner post 200. The guide surface 238 of the wedge 236 transitions into a locking surface 239 (shown in FIG. 18b) configured to engage a portion of the corner post 200, such as the pivot element 223, when the actuating link 230 is moved fully upward such that the top rail 100 is in the unfolded position. During the transition of the play yard 1000 from the folded position to the unfolded position, tension in the locking link 220 pulls the wedge 236 of the actuating link 230 against the corner post 200. In the folded position (FIGS. 21a and 21b) and the intermediate position (FIGS. 20a and 20b) of the play yard 1000, the guide surface 238 of the wedge 236 engages the corner post 200. Once the play yard 1000 reaches the unfolded position (FIGS. 18a through 19b), the locking surface 239 of the wedge 236 engages the corner post 200. The locking surface 239 is defined relative to the corner post 200 such that the horizontal component of the normal force F_{NH} exerted by the actuating link 230 prevents disengagement of the locking surface 239 from the corner post 200 due to a downward force F_{D} exerted on the top rail 100. Instead, the locking surface 239 of the wedge 236 may be disengaged from the corner post 200 by raising the central hub 600 (see FIGS. 1 through 3), which relieve the horizontal component of the normal force F_{NH} exerted by the actuating link 230 against the corner post 200.

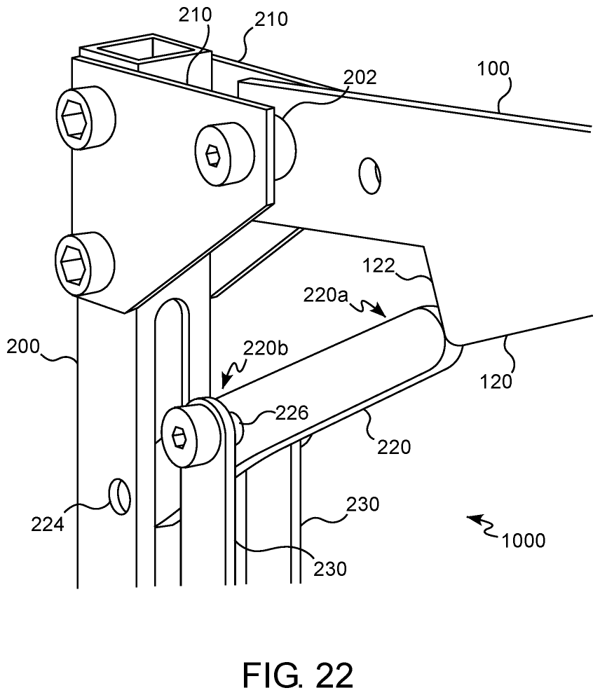

Referring now to FIGS. 22 through 25, other embodiments of the present disclosure are illustrated, which are similar to the aspect of FIGS. 3 through 17 except that the locking link 220 is not fixedly connected to the top rail 100. Rather, the second end 220b of the locking link 220 is rotatably connected to the corner post 200 at a cantilever pivot 224, and the first end 220a of locking link 220 abuts and is configured to slide along a camming surface 120 of the top rail 100. The locking link 220 is rotatably connected to the actuating link 230 at an intermediate pivot 226 located between the first and second ends of the locking link 220. The top rail 100 is rotatably connected to the upper corner bracket 210 at the upper corner pivot 202, similar to the arrangement of FIGS. 3 through 17.

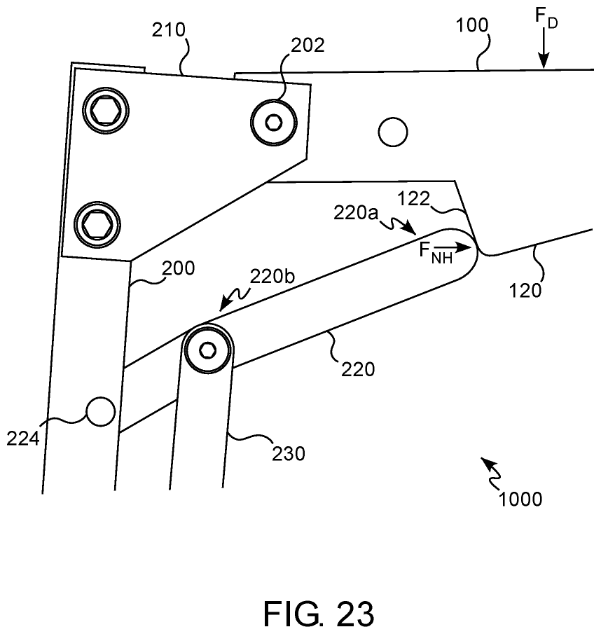

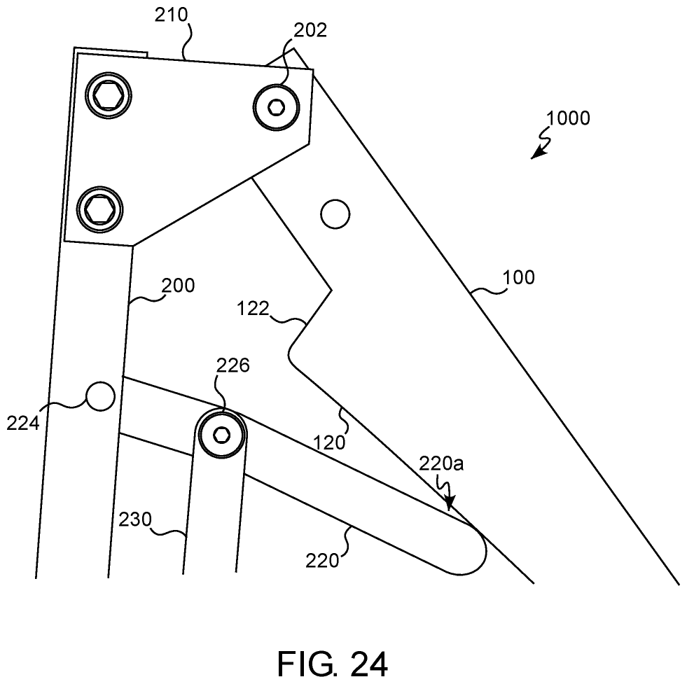

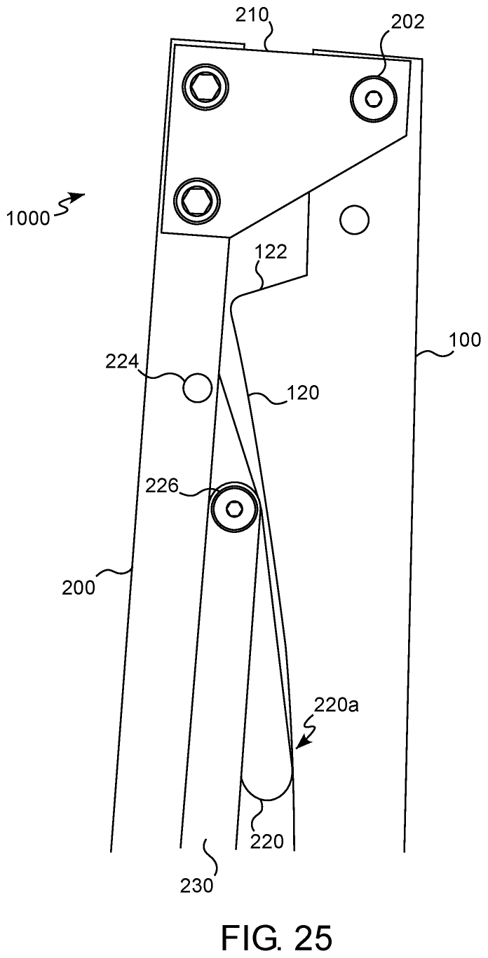

The camming surface 120 may have a curved profile such that the locking link 220 stays in contact with camming surface throughout the transition of the play yard 1000 from the unfolded position (FIGS. 22 and 23) to the folded position (FIG. 25) and vice versa. The curved profile of the camming surface 120 may also be designed to dictate the position of the top rail 100 relative to the corner post 200, the locking link 220, and the actuating link 230 in the unfolded position (FIGS. 22 and 23), the intermediate position (FIG. 24), and the folded position (FIG. 25) of the play yard 1000. As the actuating link 230 slides relative to the corner post 200, the connection between the actuating link 230 and the locking link 220 forces the locking link 220 to rotate about the cantilever pivot 224. When transitioning from the unfolded position (FIGS. 22 and 23) to the folded position (FIG. 25), the rotation of the locking link 220 relative to the corner post 200 and the sliding contact between the locking link 220 and the camming surface 120 permits the top rail 100 to rotate towards the corner post 200. Conversely, when transitioning from the folded position (FIG. 25) to the unfolded position (FIGS. 22 and 23), the rotation of the locking link 220 relative to the corner post 200 and the sliding contact between the locking link 220 and the camming surface 120 forces the top rail 100 to rotate away from the corner post 200 and into the unfolded position.

The camming surface 120 may include a locking portion 122 that the locking link 220 engages in the unfolded position (FIGS. 22-23) of the play yard 1000. The locking portion 122 of the camming surface 120 may be arranged at an angle relative to the remainder of the camming surface 120 such that once the locking link 220 engages the locking portion 122 of the camming surface 120, the locking link 220 is prevented from inadvertently moving back towards the intermediate position (FIG. 24) and the folded position (FIG. 25). When in the unfolded position, the locking link 220 exerts a horizontal component of the normal force F_{NH} against the locking portion 122 of the camming surface 120 due to compression of the locking link 220. A downward force F_{D} applied to the top rail 100 increases the horizontal component of the normal force F_{NH}, thereby preventing return of the top rail 100 to the folded position. The locking link 220 may be disengaged from locking portion 122 of the camming surface 120 by raising the central hub 600, which relieves the compression on the locking link 220 and thereby allows the locking link 220 to slide off of the locking portion 122.

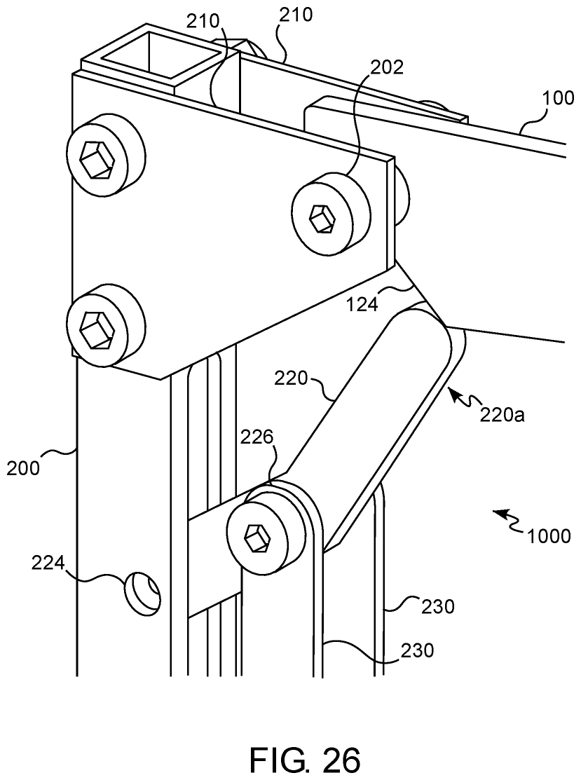

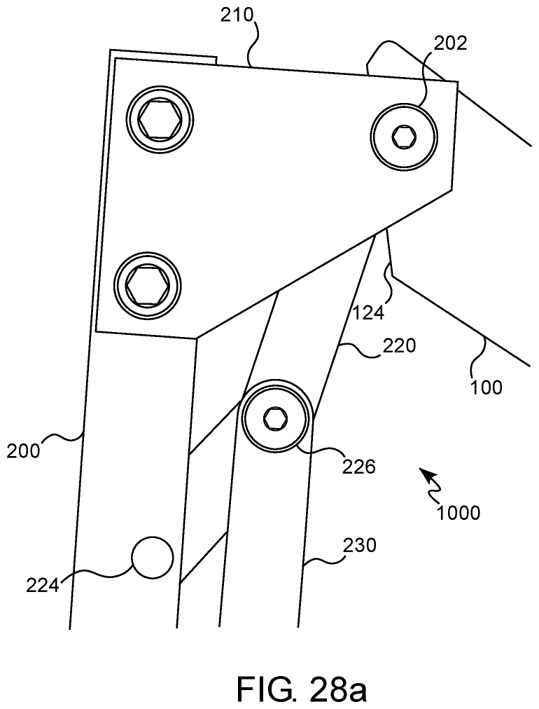

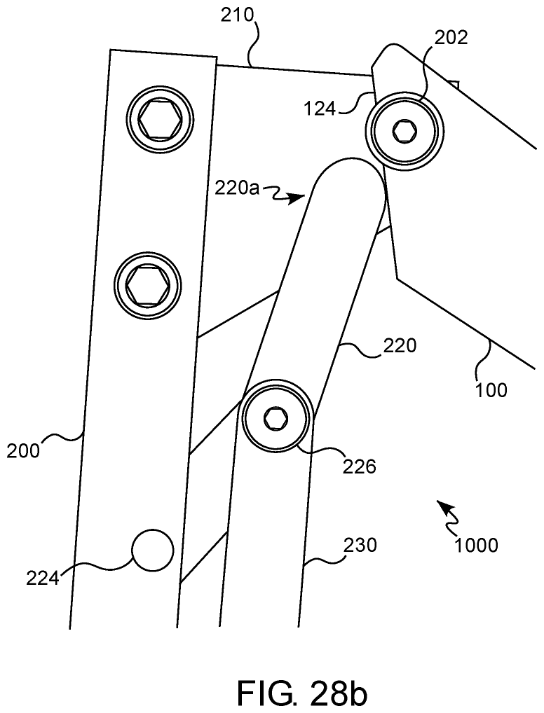

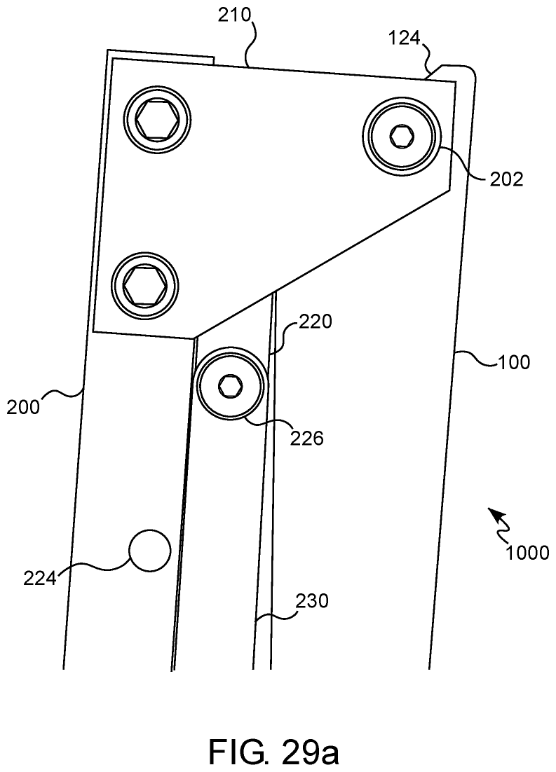

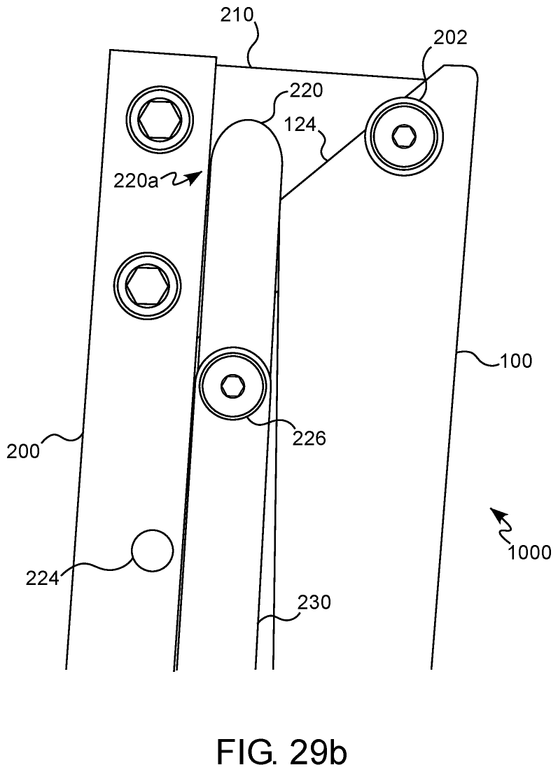

In another embodiment of the present invention, shown in FIGS. 26 through 29b, the locking link 220 is rotatably connected to the corner post 200 and the actuating link 230 in a similar manner to the aspect shown in FIGS. 22 through 25. In particular, the second end 220b of the locking link 220 is rotatably connected to the corner post 200 at a cantilever pivot 224. The locking link 220 is rotatably connected to the actuating link 230 at an intermediate pivot 226 located between the first and second ends (220a and 220b) of the locking link 220. The first end 220a of locking link 220 abuts and is configured to slide along an inverted camming surface 124 of the top rail 100. The top rail 100 is rotatably connected to the upper corner bracket 210 at the upper corner pivot 202, similar to the arrangement of FIGS. 3 through 17. FIGS. 28b and 29b are shown with a portion of the upper corner bracket 210 removed to more clearly show other components of the play yard 1000.

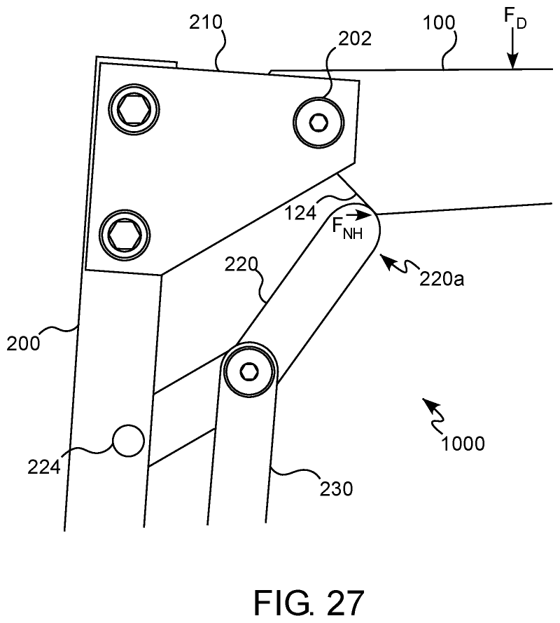

With continued reference to FIGS. 26 through 29b, operation of the actuating link 230 is reversed relative to the embodiments of FIGS. 22 through 25, such that the actuating link 230 slides upward relative to the corner post 200 as the play yard 1000 transitions from the unfolded position (FIGS. 26 and 27) to the folded position (FIGS. 29a and 29b). This relatively reversed operation of the actuating link 230 may be achieved, for example, by altering the locations of the reversing link pivot 264 and/or the lower link pivot 266 (as shown in, e.g., FIGS. 4, 5, 9, 12 and 15) such that the reversing link 260 rotates in the opposite direction of the aspects shown in FIGS. 4, 5, 9, 12 and 15. That is, as the central hub 600 is raised to transition the play yard 1000 to the folded position, the reversing link 260 rotates such that lifting link pivot 262 moves towards the corner post 200, causing the lifting link 240 to push the actuating link 230 upwards relative to the corner post 200.

Similar to the camming surface 120 shown in FIGS. 22 through 25, the inverted camming surface 124 of the embodiment of FIGS. 26 through 29a has a profile which dictates the rotation of the top rail 100 relative to the corner post 200 as the play yard 1000 transitions from the unfolded position to the folded position and vice versa. As the actuating link 230 slides relative to the corner post 200, the connection between the actuating link 230 and the locking link 220 forces the locking link 220 to rotate about the cantilever pivot 224. When transitioning from the unfolded position (FIGS. 26 and 27) to the folded position (FIGS. 29a and 29b), the rotation of the locking link 220 relative to the corner post 200 and the sliding contact between the locking link 220 and the inverted camming surface 124 permits the top rail 100 to rotate towards the corner post 200. Conversely, when transitioning from the folded position (FIGS. 29a and 29b) to the unfolded position (FIGS. 26 and 27), the rotation of the locking link 220 relative to the corner post 200 and the sliding contact between the locking link 220 and the inverted camming surface 124 forces the top rail 100 to rotate away from the corner post 200 and into the unfolded position.

When in the unfolded position, the locking link 220 exerts a horizontal component of the normal force F_{NH} against the inverted camming surface 124 due to compression of the locking link 220. A downward force F_{D} applied to the top rail 100 increases the horizontal component of the normal force F_{NH}, thereby preventing return of the top rail 100 to the folded position. The locking link 220 may be disengaged from the inverted camming surface 124 by raising the central hub 600, which relieves the compression on the locking link 220 and thereby allows the locking link 220 to slide off of the inverted camming surface 124.

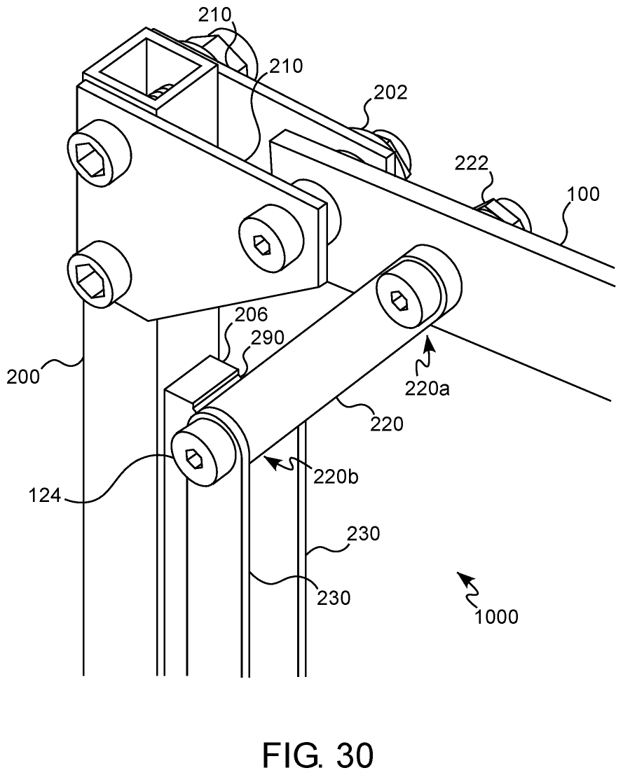

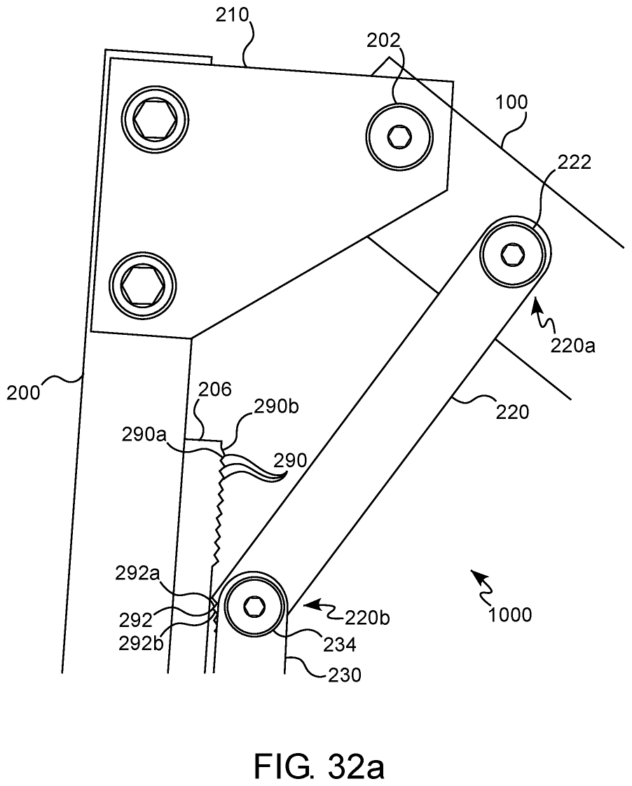

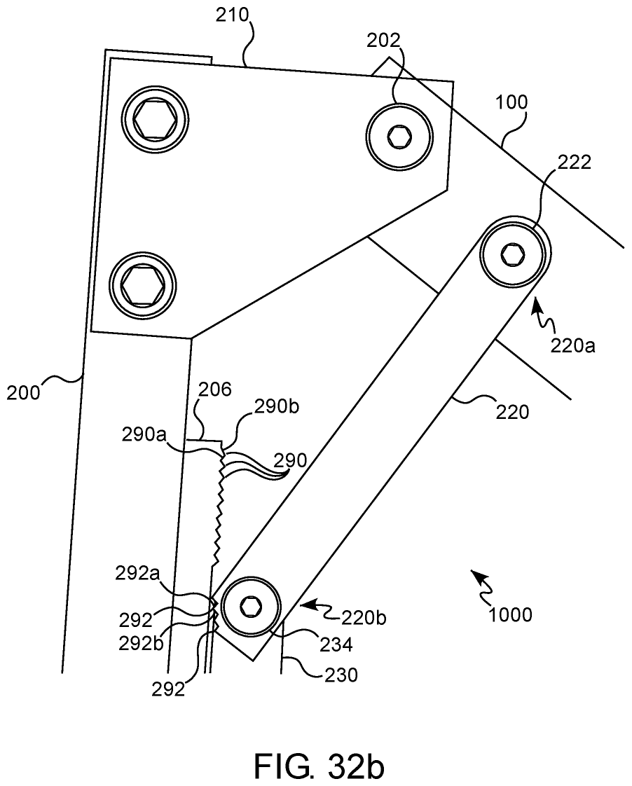

Other embodiments of the present invention, as shown in FIGS. 30 through 33, may include a ratcheting mechanism for locking the play yard 1000 in the unfolded position. The embodiment of FIGS. 30 through 33 is substantially similar to the embodiment of FIGS. 3 through 17, except that the upper bearing surface 206 of the corner post 200 includes one or more rack teeth 290 configured to engage one or more link teeth 292 projecting from the locking link 220. FIG. 32b is shown with a portion of the upper corner bracket 210 removed to more clearly show other components of the play yard 1000.

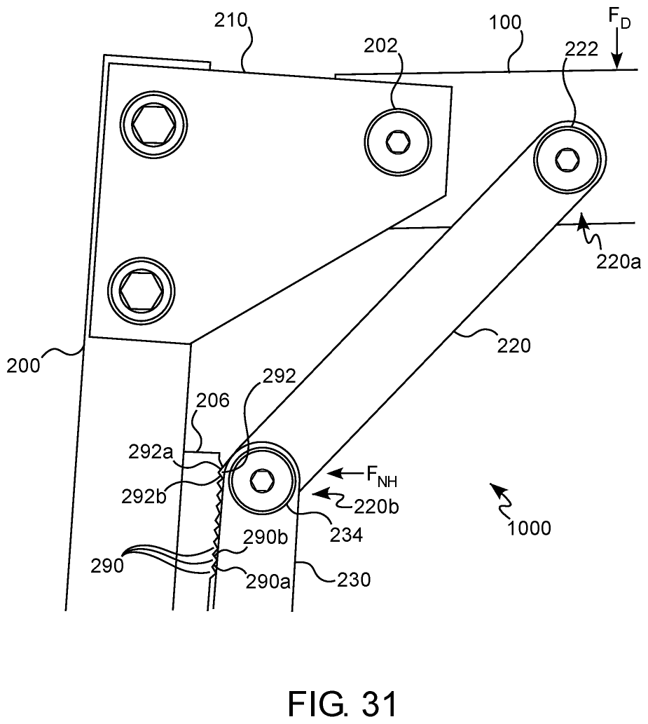

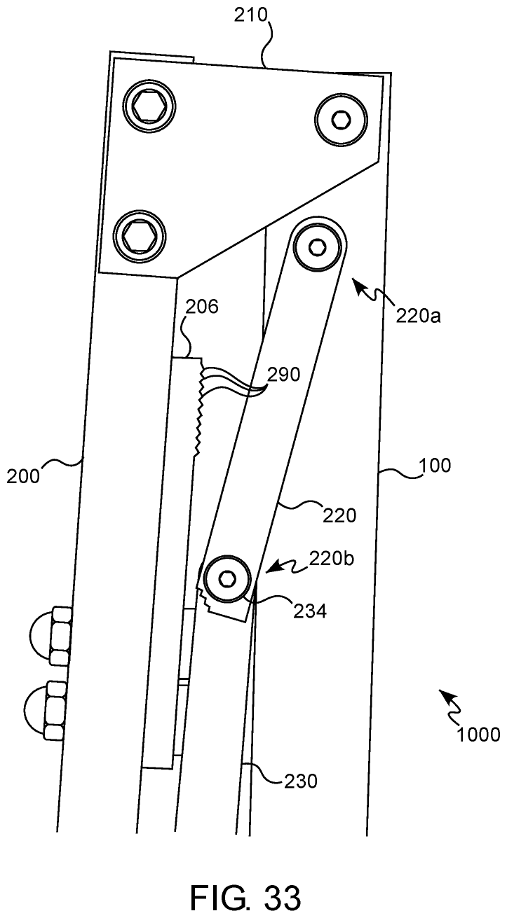

Each of the rack teeth 290 of the upper bearing surface 206 includes a sliding face 290a and a locking face 290b. Each of the link teeth 292 of the locking link 220 includes a sliding face 292a configured to interact with the sliding face 290a of one or more of the rack teeth 290. Each of the link teeth 292 of the locking link 220 further includes a locking face 292b configured to interact with the locking face 290b of one or more of the rack teeth 290. As the play yard 1000 transitions from the folded state (FIG. 33) to the unfolded state (FIGS. 30 through 31), the locking link 220 is loaded in compression and therefore exerts a horizontal component of the normal force F_{NH} against the upper bearing surface 206 of the corner post 200. As the actuating link 230 slides upward relative to the corner post 200, the sliding face 292a of at least one of the link teeth 292 engages the sliding face 290a of at least one of the rack teeth 290. The sliding faces 292a of the one or more link teeth 292 and/or the sliding faces 290a of the one or more rack teeth 290 may be sloped such that one or more of the link teeth 292 may slide completely over the one or more of the rack teeth 290, overcoming the horizontal component of the normal force F_{NH}. The locking face 292b of at least one of the link teeth 292 may then engage the locking face 290b of at least one of the rack teeth 290. The locking faces 292b of the one or more link teeth 292 and/or the locking faces 290b of the one or more rack teeth 290 may be sloped such that the horizontal component of the normal force F_{NH} prevents the link teeth 292 from sliding in a downward direction relative to the rack teeth 290. Consequently, the actuating link 230 is prevented from sliding downward relative to the corner post 200, and thus the play yard 1000 is prevented from returning to folded position.

The interaction of the rack teeth 290 and the link teeth 292 thus prevent inadvertent movement of the play yard 1000 towards the intermediate position (FIGS. 32a and 32b) and/or the folded position (FIG. 33) due to, for example, a downward force F_{D} exerted on the top rail 100. The link teeth 292 may be disengaged from the rack teeth 290, thus permitting the actuating link 230 to slide downward relative to the corner post 200, by raising the central hub 600 to relieve the compression in the locking link 220.

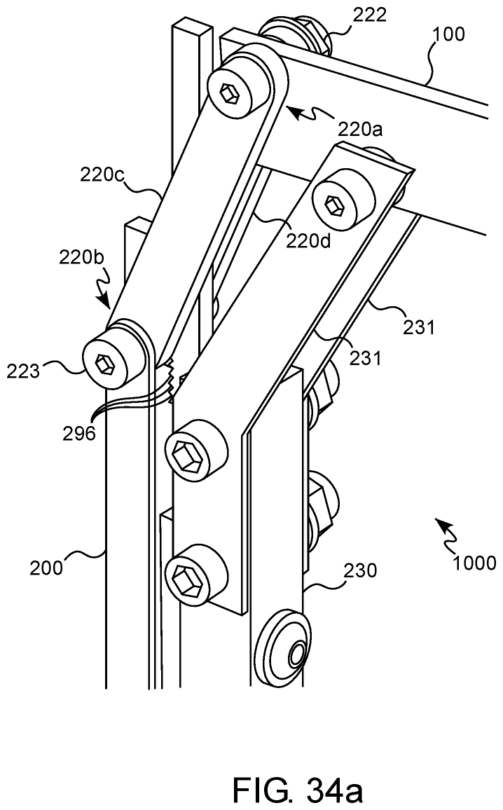

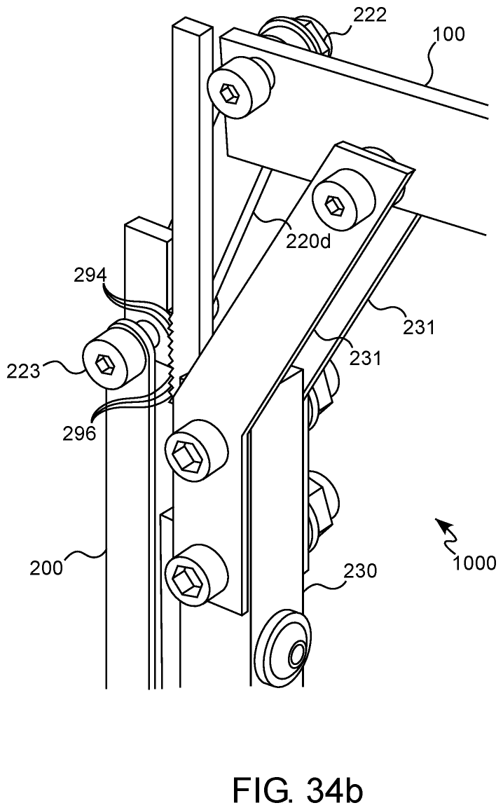

Other embodiments of the present invention, as shown in FIGS. 34a through 37, are substantially similar to the aspect shown in FIGS. 18a through 21b except that the wedge 236 is replaced by a ratcheting mechanism. In the embodiment of FIGS. 18a through 21b, like the embodiment of FIGS. 34a through 37, the second end 220b of the locking link 220 may be rotatably connected to the corner post 200. The actuating link 230 is rotatably connected to the top rail 100 via an actuating link extension 231 rigidly connected to the actuating link 230. The actuating link extension 231 is rotatably connected to the top rail 100 at location between the joint member 110 (see FIGS. 1 and 2) and the connection of the locking link 220 to the top rail 100. As shown in FIG. 34a, the locking link 220 may include two separate members 220c, 220d arranged on opposite sides of the corner post 200 and the top rail 100 to stabilize and facilitate the range of the motion of the top rail 100 and locking link 200. In FIGS. 34b, 35b and 36b, the member of the locking link in the foreground 220c is omitted so as to clearly show other components of the play yard 1000.

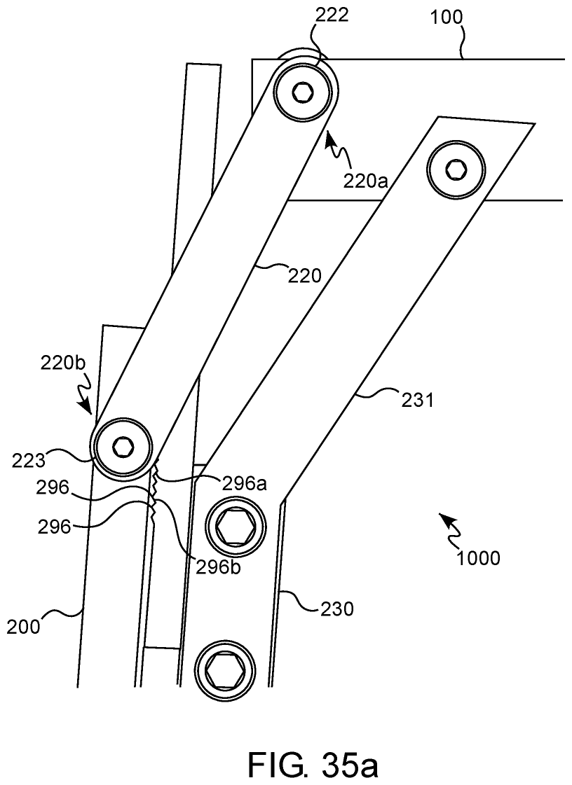

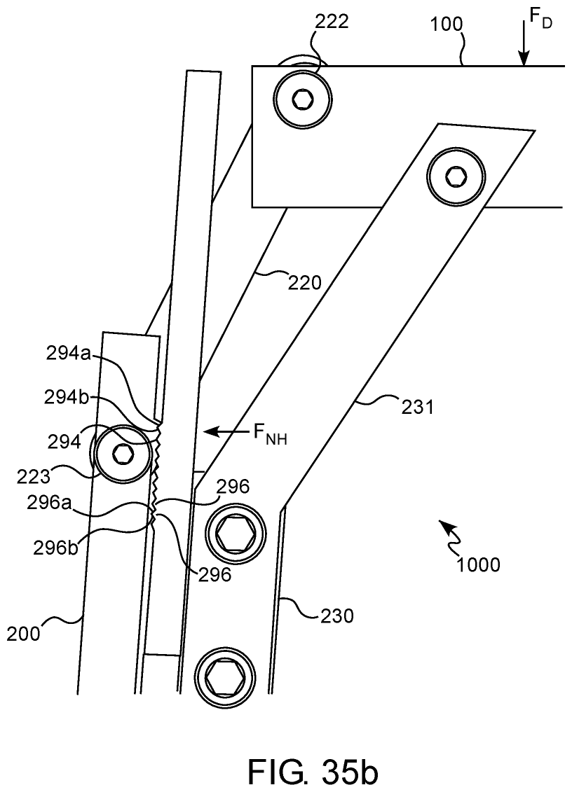

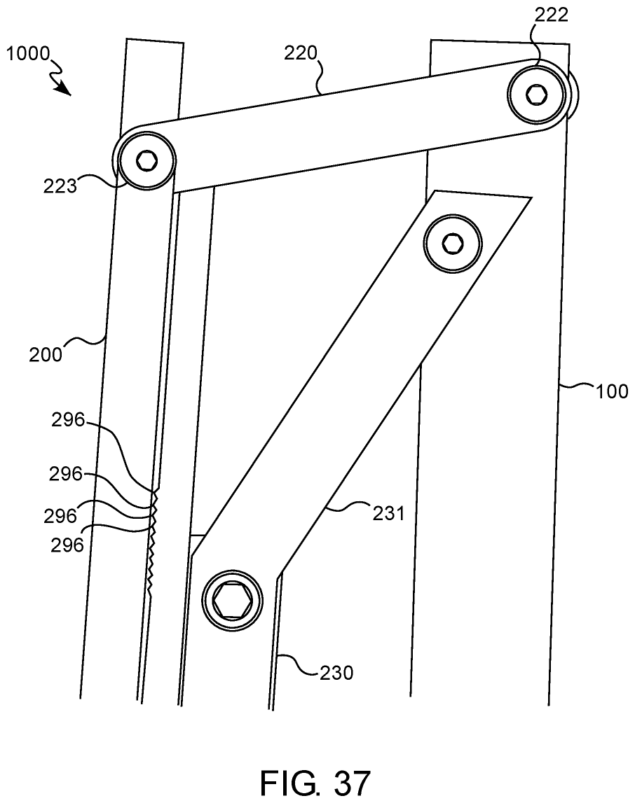

As noted above, the embodiment of the present invention shown in FIGS. 34a through 37 differs from the embodiment of FIGS. 18a through 21b in that the wedge 236 is replaced by a ratcheting mechanism. More particularly, the corner post 200 may include one or more corner post rack teeth 294 projecting therefrom and configured to interact with one or more actuating link teeth 296 projecting from the actuating link 230. Each of the corner post rack teeth 294 includes a sliding face 294a and a locking face 294b. Each of the actuating link teeth 296 includes a sliding face 296a configured to interact with the sliding face 294a of one or more of the corner post rack teeth 294. Each of the actuating link teeth 296 further includes a locking face 296b configured to interact with the locking face 294b of one or more of the corner post rack teeth 294. As the play yard 1000 transitions from the folded state (FIG. 37) to the unfolded state (FIGS. 34a through 35b), the actuating link 230 is loaded in compression and biased towards the corner post 200 by the top rail 100. The actuating link 230 therefore exerts a horizontal component of the normal force F_{NH} against the corner post 200. As the actuating link 230 slides upward relative to the corner post 200, the sliding face 296a of at least one of the actuating link teeth 296 engages the sliding face 294a of at least one of the corner post rack teeth 294. The sliding faces 296a of the one or more actuating link teeth 296 and/or the sliding faces 294a of the one or more corner post rack teeth 294 may be sloped such that one or more of the actuating link teeth 296 may slide completely over the one or more of the corner post rack teeth 294, overcoming the horizontal component of the normal force F_{NH}. The locking face 296b of at least one of the actuating link teeth 296 may then engage the locking face 294b of at least one of the corner post rack teeth 294. The locking faces 296b of the one or more actuating link teeth 296 and/or the locking faces 294b of the one or more corner post rack teeth 294 may be sloped such that the horizontal component of the normal force F_{NH} prevents the actuating link teeth 296 from sliding in a downward direction relative to the corner post rack teeth 294. Consequently, the actuating link 230 is prevented from sliding downward relative to the corner post 200, and thus the play yard 1000 is prevented from returning to folded position.

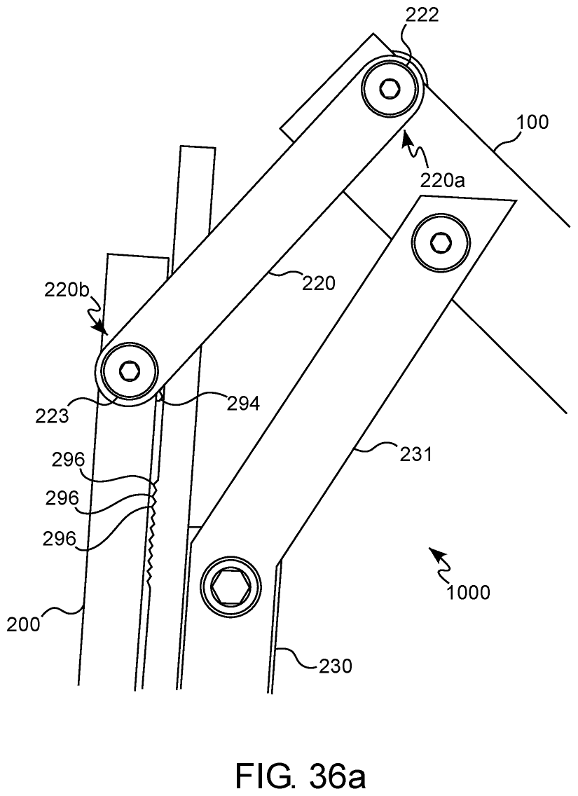

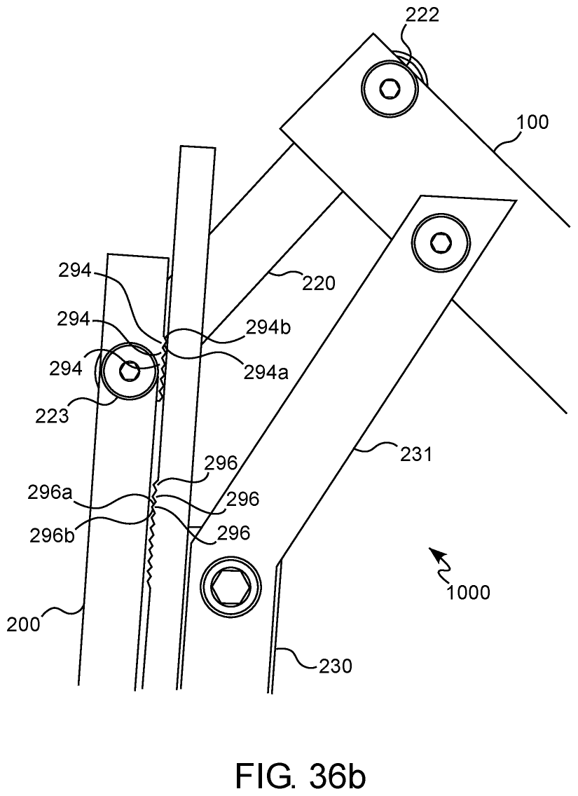

The interaction of the corner post rack teeth 294 and the actuating link teeth 296 thus prevent inadvertent movement of the play yard 1000 towards the intermediate position (FIGS. 36a and 36b) and/or the folded position (FIG. 37) due to, for example, a downward force F_{D} exerted on the top rail 100. The actuating link teeth 296 may be disengaged from the corner post rack teeth 294, thus permitting the actuating link 230 to slide downward relative to the corner post 200, by raising the central hub 600 to relieve the compression in the actuating link 230.

Although the invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements. For example, it is to be understood that the present invention contemplates that to the extent possible, one or more features of any embodiment can be combined with one or more features of any other embodiment.

What is claimed is:

1. A foldable play yard, comprising:
a plurality of corner posts;
a plurality of top rails, each top rail having two opposing ends, and each of the opposing ends of each of the plurality of the top rails rotatably connected to one of the plurality of corner posts to define a polygonal shape;
a plurality of reversing links corresponding to the plurality of corner posts, with each reversing link having a first, second and third connection point, and each of the plurality of reversing links rotatably connected at the second connection point of each reversing link to the corresponding corner post;
a central hub;
a plurality of lower linkage assemblies corresponding to the reversing links, with each lower linkage assembly having a first and second end, and each of the plurality of lower linkage assemblies rotatably connected at the first end of each lower linkage assembly to the third connection point of the corresponding reversing link and, at the second end of each lower linkage assembly, rotatably connected to the central hub;
a plurality of post linkage assemblies corresponding to the reversing links, with each post linkage assembly having a first and second end, and each of the plurality of post linkage assemblies rotatably connected at the first end of each post linkage assembly to one or more of the top rails and, at the second end of each post linkage assembly, rotatably connected to the first connection point of the corresponding reversing link; and
at least one locking mechanism having an actuating link comprising a wedge, the actuating link slidably connected to one of the plurality of corner posts and rotatably connected to one of the plurality of top rails connected to the one corner post and a locking link rotatably connected to the one corner post and rotatably connected to the one of the plurality of top rails connected to the one corner post, wherein the wedge includes a sliding surface configured to slide along a portion of the one corner post as the actuating link slides relative to the one corner post, and wherein the wedge includes a locking surface configured to lock in place on the portion of the one corner post which the wedge is configured to slide along;
wherein lowering the central hub causes each of the lower linkage assemblies to rotate relative to the corresponding corner posts in a first direction,
wherein rotation of each of the lower linkage assemblies in the first direction causes each of the reversing links to rotate relative to the corresponding corner posts in a second direction opposite the first direction, and
wherein rotation of the reversing links in the second direction drives the post linkage assemblies to rotate the top rails relative to the corner posts.

2. A locking mechanism for a foldable play yard, the foldable play yard comprising a plurality of corner posts and a plurality of top rails, each of the top rails rotatably connected to two of the plurality of corner posts to define a polygonal shape, the locking mechanism comprising:
an actuating link slidably connected to one of the plurality of corner posts;
a locking link rotatably connected to the actuating link and rotatably connected to one of the plurality of top rails connected to the one of the plurality of corner posts;
a guide roller rotatably connected to the actuating link; and
a guide pad connected to the one of the plurality of corner posts, the guide pad including a slanted top surface;
wherein the guide roller is configured to roll along the guide pad as the actuating link slides relative to the one corner post, and
wherein the top slanted surface of the guide pad is configured to lock the guide roller in place when the guide roller passes over the slanted top surface.

3. A locking mechanism for a foldable play yard, the foldable play yard comprising a plurality of corner posts and a plurality of top rails, the locking mechanism comprising:
an actuating link comprising a wedge, the actuating link slidably connected to one of the plurality of corner posts and rotatably connected to one of the plurality of top rails connected to the one corner post; and
a locking link rotatably connected to the one corner post and rotatably connected to the one of the plurality of top rails;
wherein the wedge includes a sliding surface configured to slide along a portion of the one corner post as the actuating link slides relative to the one corner post, and
wherein the wedge includes a locking surface configured to lock in place on the portion of the one corner post which the wedge is configured to slide along.

4. A foldable play yard, comprising:
a plurality of corner posts;
a plurality of top rails, each top rail having two opposing ends, and each of the opposing ends of each of the plurality of the top rails rotatably connected to one of the plurality of corner posts to define a polygonal shape;
a plurality of reversing links corresponding to the plurality of corner posts, with each reversing link having a first, second and third connection point, and each of the plurality of reversing links rotatably connected at the second connection point of each reversing link to the corresponding corner posts;
a central hub;
a plurality of lower linkage assemblies corresponding to the reversing links, with each lower linkage assembly having a first and second end, and each of the plurality of lower linkage assemblies rotatably connected at the first end of each lower linkage assembly to the third connection point of the corresponding reversing link and, at the second end of each lower linkage assembly, rotatably connected to the central hub; and
a plurality of post linkage assemblies corresponding to the reversing links, with each post linkage assembly having a first and second end, and each of the plurality of post linkage assemblies rotatably connected at the first end of each post linkage assembly to one or more of the top rails and, at the second end of each post linkage assembly, rotatably connected to the first connection point of the corresponding reversing links; and
at least one locking mechanism having an actuating link slidably connected to one of the plurality of corner posts and a locking link rotatably connected to the actuating link, rotatably connected to the one corner post, and slidable along a camming surface of the one of the plurality of top rails; wherein the locking link is configured to slide along the camming surface as the actuating link slides relative to the one corner post;
wherein lowering the central hub causes each of the lower linkage assemblies to rotate relative to the corresponding corner posts in a first direction,
wherein rotation of each of the lower linkage assemblies in the first direction causes each of the reversing links to rotate relative to the corresponding corner posts in a second direction opposite the first direction, and
wherein rotation of the reversing links in the second direction drives the post linkage assemblies to rotate the top rails relative to the corner posts.

5. A locking mechanism for a foldable play yard, the foldable play yard comprising a plurality of corner posts and a plurality of top rails, each of the top rails rotatably connected to two of the plurality of corner posts to define a polygonal shape, the locking mechanism comprising:
an actuating link slidably connected to one of the plurality of corner posts;
a locking link rotatably connected to the actuating link, rotatably connected to the one of the plurality of corner posts, and slidable along a camming surface of one of the plurality of top rails;
wherein the locking link is configured to slide along the camming surface as the actuating link slides relative to the one of the plurality of corner posts.

6. The locking mechanism of claim 5, wherein the camming surface includes a locking portion configured to receive the locking link and prevent further sliding of the locking link along the camming surface.

7. A locking mechanism for a foldable play yard, the foldable play yard comprising a plurality of corner posts and a plurality of top rails, each of the top rails rotatably connected to two of the plurality of corner posts to define a polygonal shape, the locking mechanism comprising:
an actuating link slidably connected to one of the plurality of corner posts;
a locking link rotatably connected to the actuating link and rotatably connected to one of the plurality of top rails;
one or more rack teeth connected to the one of the plurality of corner posts; and
one or more link teeth projecting from the locking link;
wherein the one or more link teeth are configured to engage the one or more rack teeth as the actuating link slides relative to the one of the plurality of corner posts.

8. The locking mechanism of claim 7, wherein each of the one or more rack teeth comprises:
a sliding face configured to permit sliding of the one or more link teeth over the sliding face in a first direction; and
a locking face configured to prevent sliding of the one or more link teeth over the locking face in a second direction.

9. The locking mechanism of claim 7, wherein each of the one or more link teeth comprises:
a sliding face configured to permit sliding of the one or more rack teeth over the sliding face in a first direction; and
a locking face configured to prevent sliding of the one or more rack teeth over the locking face in a second direction.

10. A locking mechanism for a foldable play yard, the foldable play yard comprising a plurality of corner posts and a plurality of top rails, the locking mechanism comprising:
an actuating link slidably connected to one of the plurality of corner posts and rotatably connected to one of the plurality of top rails;
a locking link rotatably connected to the one of the plurality of corner posts and rotatably connected to the one of the plurality of top rails;
one or more rack teeth connected to the one of the plurality of corner posts; and
one or more link teeth projecting from the actuating link;
wherein the one or more link teeth are configured to engage the one or more rack teeth as the actuating link slides relative to the one of the plurality of corner posts.

11. The locking mechanism of claim 10, wherein each of the one or more rack teeth comprises:
a sliding face configured to permit sliding of the one or more link teeth over the sliding face in a first direction; and
a locking face configured to prevent sliding of the one or more link teeth over the locking face in a second direction.

12. The locking mechanism of claim 10, wherein each of the one or more link teeth comprises:
a sliding face configured to permit sliding of the one or more rack teeth over the sliding face in a first direction; and
a locking face configured to prevent sliding of the one or more rack teeth over the locking face in a second direction.
